(19) United States
(12) Patent Application Publication
(10) Pub. No.: US 2025/0182432 A1
(43) Pub. Date: Jun. 5, 2025

(54) OBJECT DETECTION VIA PANORAMIC IMAGE REGIONS OF INTEREST

(71) Applicant: SimpliSafe, Inc., Boston, MA (US)

(72) Inventors: Shekhar Bangalore Sastry, Arlington, MA (US); Nicholas Setzer, Boston, MA (US); Monica Xu, Cambridge, MA (US); Alexander Pollack, Pinellas, FL (US); Shreyas Kamath Kalasa Mohandas, Medford, MA (US)

(21) Appl. No.: 18/526,245

(22) Filed: Dec. 1, 2023

(51) Int. Cl. G06V 10/25; G06T 3/40; G06V 20/52; G08B 21/00

(52) U.S. Cl. CPC G06V 10/25; G06T 3/40; G06V 20/52; G08B 21/00; G06V 2201/07

(57) ABSTRACT

A method is provided. The method includes resizing a frame of pixels based on at least one dimension of an operating resolution; selecting a plurality of regions of interest within the frame; identifying an object based on pixels within at least one region of interest of the plurality of regions of interest; and issuing an alarm in response to the at least one region of interest including the object.

### TECHNICAL FIELD

Aspects of the technologies described herein relate to security systems and methods.

### BACKGROUND

Some monitoring systems use one or more cameras to capture images of areas around or within a residence or business location. Such monitoring systems can process images locally and transmit the captured images to a remote service. If motion is detected, the monitoring systems can send an alert to one or more user devices.

### SUMMARY

This disclosure is directed to techniques to identify objects depicted within images. One example is directed to a method. The method includes resizing a frame of pixels based on at least one dimension of an operating resolution; selecting a plurality of regions of interest within the frame; identifying an object based on pixels within at least one region of interest of the plurality of regions of interest; and issuing an alarm in response to the at least one region of interest including the object.

Another example is directed to a security device. The security device is configured to communicate data generated by at least one sensor disposed in a location being monitored. The security device includes a memory; and at least one processor coupled with the memory and configured to resize a frame of pixels based on at least one dimension of an operating resolution, select a plurality of regions of interest within the frame, identify an object based on pixels within at least one region of interest of the plurality of regions of interest, and issue an alarm in response to the at least one region of interest including the object.

Another example is directed to one or more computer readable media. The media store sequences of instructions executable to identify objects depicted within images. The sequences of instructions include instructions to resize a frame of pixels based on at least one dimension of an operating resolution; select a plurality of regions of interest within the frame; identify an object based on pixels within at least one region of interest of the plurality of regions of interest; and issue an alarm in response to the at least one region of interest including the object.

### BRIEF DESCRIPTION OF THE DRAWINGS

Additional examples of the disclosure, as well as features and advantages thereof, will become more apparent by reference to the description herein taken in conjunction with the accompanying drawings which are incorporated in and constitute a part of this disclosure. The figures are not necessarily drawn to scale.

FIG. 1 is a schematic diagram of a security system, according to some examples described herein.

FIG. 2 is a schematic diagram of a base station, according to some examples described herein.

FIG. 3 is a schematic diagram of a keypad, according to some examples described herein.

FIG. 4A is a schematic diagram of a security sensor, according to some examples described herein.

FIG. 4B is a schematic diagram of an image capture device, according to some examples described herein.

FIG. 4C is a schematic diagram of another image capture device, according to some examples described herein.

FIG. 5 is a schematic diagram of a data center environment, a monitoring center environment, and a customer device, according to some examples described herein.

FIG. 6 is a sequence diagram of a monitoring process, according to some examples described herein.

FIG. 7 is a schematic diagram of a security device according to some examples described herein.

FIG. 8 is a sequence diagram of an operational process executed by features of the security device of FIG. 7, according to some examples described herein.

FIG. 9 is a flow diagram of an object detection process, according to some examples described herein.

FIG. 10 is a schematic diagram illustrating a resizing process being applied to a frame of image data, according to some examples described herein.

FIG. 11 is a schematic diagram illustrating a process of defining regions of interest being applied to image data, according to some examples described herein.

FIG. 12 is a schematic diagram illustrating model application, translation, and filtering processes being applied to image data, according to some examples described herein.

FIG. 13 is a schematic diagram of a computing device, according to some examples described herein.

### DETAILED DESCRIPTION

As summarized above, at least some examples disclosed herein are directed to systems and processes that detect objects represented within image data. In some implementations, these systems and processes are utilized in security systems to efficiently monitor spaces that are physically proximal to the devices that surveil the spaces. In these implementations, the systems and processes take advantage of this physical proximity to utilize object detection models with operating resolutions that are relatively smaller than operating resolutions of other object detection models, as will be described further below. The advantages taken include, among others, reduced power consumption, reduced false positive detection of security threats, and/or improved detection of small objects.

Security systems can include a range of sensors configured to detect various events, such as motion, moisture, temperature changes, and sounds, among others. For example, passive infrared (PIR) sensors are motion sensors that detect changes in temperature in a field of view. The PIR sensors can be configured with a threshold such that any change larger than the threshold constitutes motion and causes a motion trigger. Imaging sensors can be capable of distinguishing between certain objects, such as people, for example, in captured image frames. The image sensors can be configured to trigger an object detection alert if an object of interest is identified within an image frame. Imaging sensors can use any of a variety of techniques to locate and recognize objects in a frame. For example, computer vision based object detection can use specialized filters to locate different attributes or features within an image frame and then combine the features to classify whether or not a particular category of object is found. For example, an object detector can locate all human faces in a frame. Recently, machine learning (ML) or artificial intelligence (AI) based approaches have come into use wherein processes or models are trained on a vast number of images containing objects of interest to recognize similar objects in new or unseen images.

When deploying AI or ML models within security systems that include battery powered devices, some poignant concerns and constraints are memory volume and model efficiency. One practice to work in favor of these constraints is to deploy smaller models, both in model size as well as operating resolution. A smaller operating resolution for model inference can allow for lower power consumption and improved inference rates due to decreased computational complexity. However, models with smaller operating resolutions may require image preprocessing including padding (for reshaping) or resizing of images to fit the model input dimensions because images sampled from a video can have a variety of aspect ratios. Images can be square, where the width and height are the same. Images can be landscape, where the width is greater than the height. Images can also be portrait, where the height is greater than the width. When dealing with images having various aspect ratios, the preprocessing steps described above can lead to distortion of the original image context such as pixel data loss in downsampling or the shrinking of objects relative size within the image. These issues can pose problems for how effectively a model can detect objects within image frames, especially in the case of relatively small objects, which when downsampling have the potential to be virtually erased.

In view of these and other concerns and constraints, at least some of the examples disclosed herein preserve image data and context for certain images (e.g. wide aspect-ratio images) by cropping the image into 3 regions of interest (e.g., crops) with overlapping context. For instance, in some examples, left, center, and right regions of interest can include or otherwise be based on left, center, and right crops identified within the image. Cropping is different from reshaping or resizing in that cropping removes unwanted background from an image, thereby increasing the percentage of pixels in the image used to depict objects within a region of interest. Resizing an image, which can involve upsampling or downsampling, alters resolution of the image while preserving proportionality of the original content. Reshaping an image alters its aspect ratio and can involve insertion of padding (added pixels). In some examples, regions of interest can be created at or near the size of model input dimensions, which allows for minimal to no downsampling. Additionally, square regions of interest can be taken from the image, which is typically required for model input, allowing for no further padding or image reshaping. This approach prevents distortion by allowing a larger image to be passed to a model as well as preserving the structural context of the objects that reside within the frame. This is so because cropping does not alter pixels within the region of interest nor their proportionality relative to one another. This use of square regions of interests also allows for using models trained on square aspect ratio images to be used in a wide aspect ratio context. This aspect is advantageous because models operate best when applied to images having the same or similar dimensions. These and other aspects and advantages of various examples are described further below.

Whereas various examples are described herein, it will be apparent to those of ordinary skill in the art that many more examples and implementations are possible. Accordingly, the examples described herein are not the only possible examples and implementations. Furthermore, the advantages described above are not necessarily the only advantages, and it is not necessarily expected that all of the described advantages will be achieved with every example.

For the purpose of promoting an understanding of the principles of the present disclosure, reference will now be made to the examples illustrated in the drawings, and specific language will be used to describe the same. It will nevertheless be understood that no limitation of the scope of the examples described herein is thereby intended.

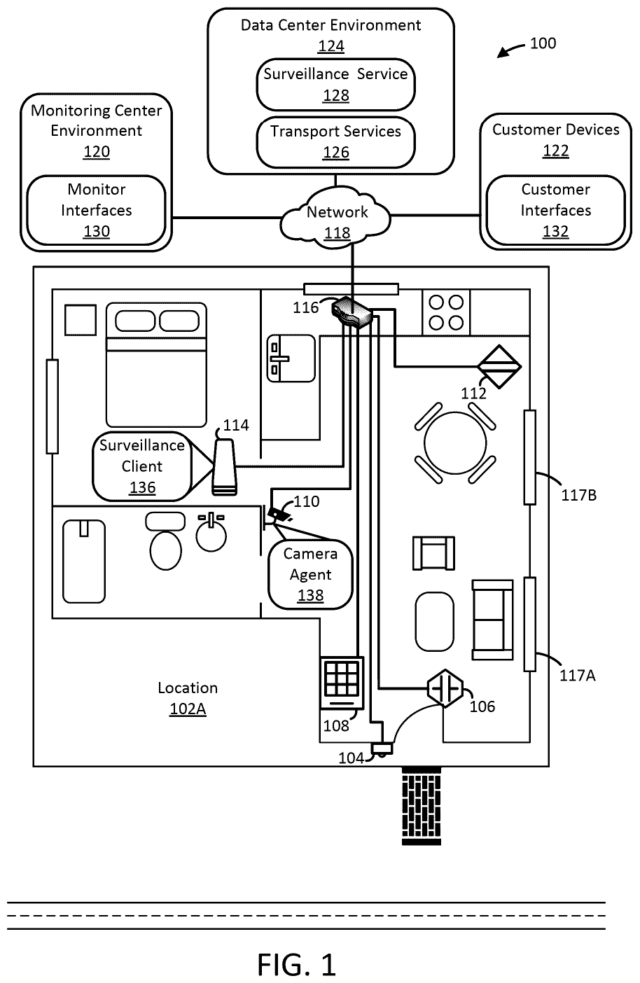

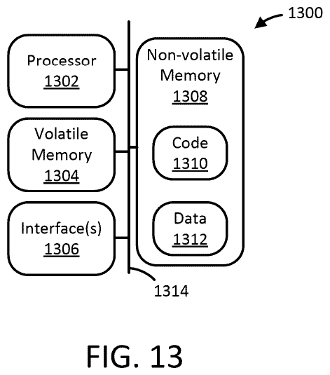

FIG. 1 is a schematic diagram of a security system 100 configured to monitor geographically disparate locations in accordance with some examples. As shown in FIG. 1, the system 100 includes a monitored location 102A, a monitoring center environment 120, a data center environment 124, one or more customer devices 122, and a communication network 118. Each of the monitored location 102A, the monitoring center environment 120, the data center environment 124, the one or more customer devices 122, and the communication network 118 include one or more computing devices (e.g., as described below with reference to FIG. 13). The one or more customer devices 122 are configured to host one or more customer interface applications 132. The monitoring center environment 120 is configured to host one or more monitor interface applications 130. The data center environment 124 is configured to host a surveillance service 128 and one or more transport services 126. The location 102A includes image capture devices 104 and 110, a contact sensor assembly 106, a keypad 108, a motion sensor assembly 112, a base station 114, and a router 116. The base station 114 hosts a surveillance client 136. The image capture device 110 hosts a camera agent 138. The security devices disposed at the location 102A (e.g., devices 104, 106, 108, 110, 112, and 114) may be referred to herein as location-based devices.

In some examples, the router 116 is a wireless router that is configured to communicate with the location-based devices via communications that comport with a communications standard such as any of the various Institute of Electrical and Electronics Engineers (IEEE) 802.11 standards. As illustrated in FIG. 1, the router 116 is also configured to communicate with the network 118. It should be noted that the router 116 implements a local area network (LAN) within and proximate to the location 102A by way of example only. Other networking technology that involves other computing devices is suitable for use within the location 102A. For instance, in some examples, the base station 114 can receive and forward communication packets transmitted by the image capture device 110 via a personal area network (PAN) protocol, such as BLUETOOTH. Additionally or alternatively, in some examples, the location-based devices communicate directly with one another using any of a variety of standards suitable for point-to-point use, such as any of the IEEE 802.11 standards, PAN standards, etc. In at least one example, the location-based devices can communicate with one another using a sub-GHz wireless networking standard, such as IEEE 802.11ah, Z-WAVE, ZIGBEE, etc.). Other wired, wireless, and mesh network technology and topologies will be apparent with the benefit of this disclosure and are intended to fall within the scope of the examples disclosed herein.

Continuing with the example of FIG. 1, the network 118 can include one or more public and/or private networks that support, for example, IP. The network 118 may include, for example, one or more LANs, one or more PANs, and/or one or more wide area networks (WANs). The LANs can include wired or wireless networks that support various LAN standards, such as a version of IEEE 802.11 and the like. The PANs can include wired or wireless networks that support various PAN standards, such as BLUETOOTH, ZIGBEE, and the like. The WANs can include wired or wireless networks that support various WAN standards, such as the Code Division Multiple Access (CDMA) radio standard, the Global System for Mobiles (GSM) radio standard, and the like. The network 118 connects and enables data communication between the computing devices within the location 102A, the monitoring center environment 120, the data center environment 124, and the customer devices 122. In at least some examples, both the monitoring center environment 120 and the data center environment 124 include network equipment (e.g., similar to the router 116) that is configured to communicate with the network 118 and computing devices collocated with or near the network equipment. It should be noted that, in some examples, the network 118 and the network extant within the location 102A support other communication protocols, such as MQTT or other IoT protocols.

Continuing with the example of FIG. 1, the data center environment 124 can include physical space, communications, cooling, and power infrastructure to support networked operation of computing devices. For instance, this infrastructure can include rack space into which the computing devices are installed, uninterruptible power supplies, cooling plenum and equipment, and networking devices. The data center environment 124 can be dedicated to the security system 100, can be a non-dedicated, commercially available cloud computing service (e.g., MICROSOFT AZURE, AMAZON WEB SERVICES, GOOGLE CLOUD, or the like), or can include a hybrid configuration made up of dedicated and non-dedicated resources. Regardless of its physical or logical configuration, as shown in FIG. 1, the data center environment 124 is configured to host the surveillance service 128 and the transport services 126.

Continuing with the example of FIG. 1, the monitoring center environment 120 can include a plurality of computing devices (e.g., desktop computers) and network equipment (e.g., one or more routers) connected to the computing devices and the network 118. The customer devices 122 can include personal computing devices (e.g., a desktop computer, laptop, tablet, smartphone, or the like) and network equipment (e.g., a router, cellular modem, cellular radio, or the like). As illustrated in FIG. 1, the monitoring center environment 120 is configured to host the monitor interfaces 130 and the customer devices 122 are configured to host the customer interfaces 132.

Continuing with the example of FIG. 1, the devices 104, 106, 110, and 112 are configured to acquire analog signals via sensors incorporated into the devices, generate digital sensor data based on the acquired signals, and communicate (e.g. via a wireless link with the router 116) the sensor data to the base station 114. The type of sensor data generated and communicated by these devices varies along with the type of sensors included in the devices. For instance, the image capture devices 104 and 110 can acquire ambient light, generate frames of image data based on the acquired light, and communicate the frames to the base station 114, the monitor interfaces 130, and/or the customer interfaces 132, although the pixel resolution and frame rate may vary depending on the capabilities of the devices. Where the image capture devices 104 and 110 have sufficient processing capacity and available power, the image capture devices 104 and 110 can process the image frames and transmit messages based on content depicted in the image frames, as described further below. These messages may specify reportable events and may be transmitted in place of, or in addition to, the image frames. Such messages may be sent directly to another location-based device (e.g., via sub-GHz networking) and/or indirectly to any device within the system 100 (e.g., via the router 116). As shown in FIG. 1, the image capture device 104 has a field of view (FOV) that originates proximal to a front door of the location 102A and can acquire images of a walkway, highway, and a space between the location 102A and the highway. The image capture device 110 has an FOV that originates proximal to a bathroom of the location 102A and can acquire images of a living room and dining area of the location 102A. The image capture device 110 can further acquire images of outdoor areas beyond the location 102A through windows 117A and 117B on the right side of the location 102A.

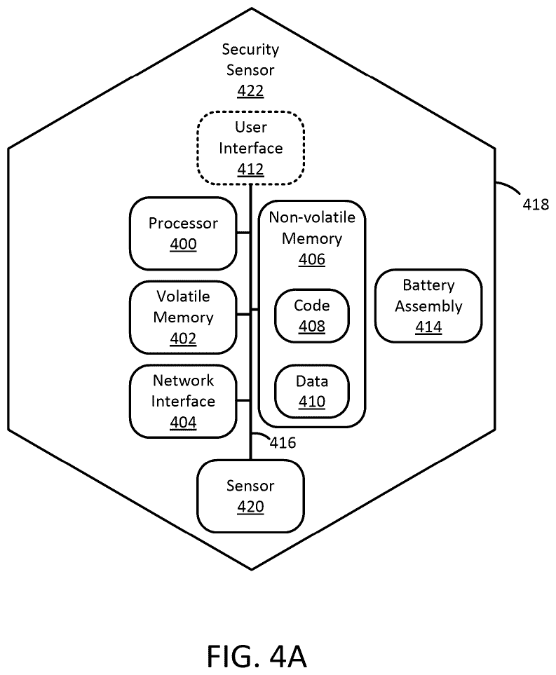

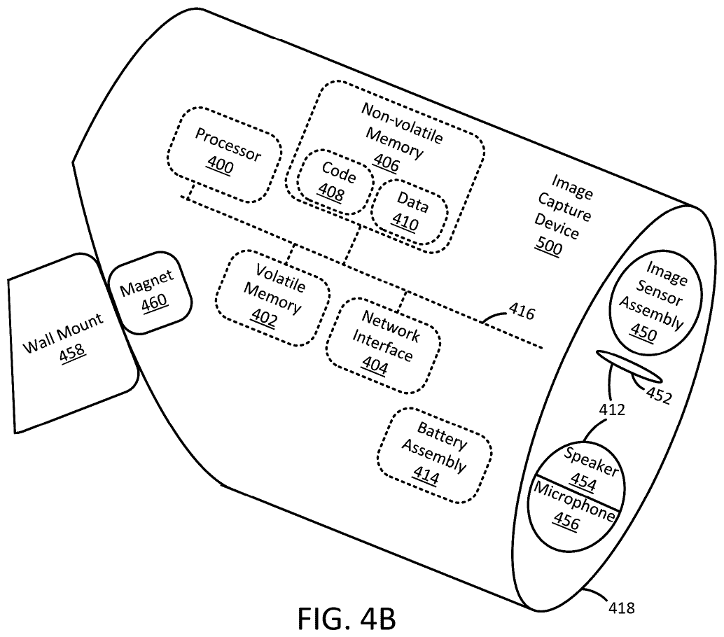

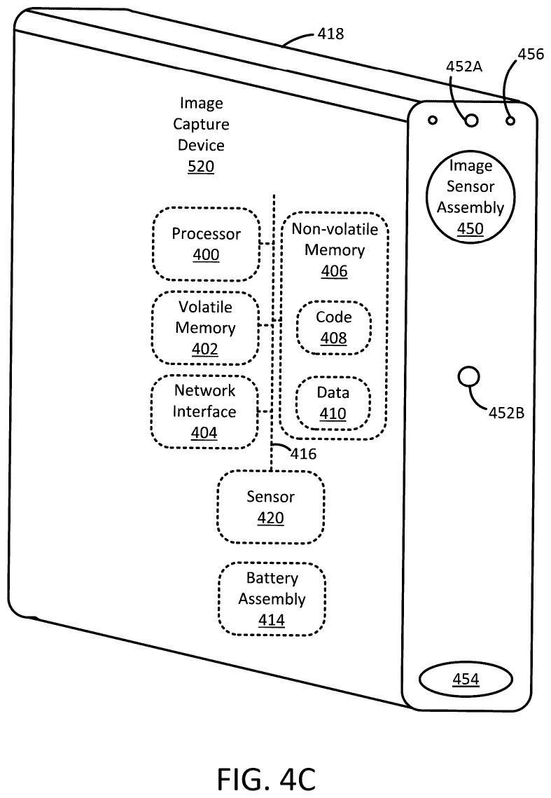

Further, as shown in FIG. 1, in some examples the image capture device 110 is configured to communicate with the surveillance service 128, the monitor interfaces 130, and the customer interfaces 132 separately from the surveillance client 136 via execution of the camera agent 138. These communications can include sensor data generated by the image capture device 110 and/or commands to be executed by the image capture device 110 sent by the surveillance service 128, the monitor interfaces 130, and/or the customer interfaces 132. The commands can include, for example, requests for interactive communication sessions in which monitoring personnel and/or customers interact with the image capture device 110 via the monitor interfaces 130 and the customer interfaces 132. These interactions can include requests for the image capture device 110 to transmit additional sensor data and/or requests for the image capture device 110 to render output via a user interface (e.g., the user interface 412 of FIGS. 4B & 4C). This output can include audio and/or video output.

Continuing with the example of FIG. 1, the contact sensor assembly 106 includes a sensor that can detect the presence or absence of a magnetic field generated by a magnet when the magnet is proximal to the sensor. When the magnetic field is present, the contact sensor assembly 106 generates Boolean sensor data specifying a closed state. When the magnetic field is absent, the contact sensor assembly 106 generates Boolean sensor data specifying an open state. In either case, the contact sensor assembly 106 can communicate sensor data indicating whether the front door of the location 102A is open or closed to the base station 114. The motion sensor assembly 112 can include an audio emission device that can radiate sound (e.g., ultrasonic) waves and an audio sensor that can acquire reflections of the waves. When the audio sensor detects the reflection because no objects are in motion within the space monitored by the audio sensor, the motion sensor assembly 112 generates Boolean sensor data specifying a still state. When the audio sensor does not detect a reflection because an object is in motion within the monitored space, the motion sensor assembly 112 generates Boolean sensor data specifying an alarm state. In either case, the motion sensor assembly 112 can communicate the sensor data to the base station 114. It should be noted that the specific sensing modalities described above are not limiting to the present disclosure. For instance, as one of many potential examples, the motion sensor assembly 112 can base its operation on acquisition of changes in temperature rather than changes in reflected sound waves.

Continuing with the example of FIG. 1, the keypad 108 is configured to interact with a user and interoperate with the other location-based devices in response to interactions with the user. For instance, in some examples, the keypad 108 is configured to receive input from a user that specifies one or more commands and to communicate the specified commands to one or more addressed processes. These addressed processes can include processes implemented by one or more of the location-based devices and/or one or more of the monitor interfaces 130 or the surveillance service 128. The commands can include, for example, codes that authenticate the user as a resident of the location 102A and/or codes that request activation or deactivation of one or more of the location-based devices. Alternatively or additionally, in some examples, the keypad 108 includes a user interface (e.g., a tactile interface, such as a set of physical buttons or a set of virtual buttons on a touchscreen) configured to interact with a user (e.g., receive input from and/or render output to the user). Further still, in some examples, the keypad 108 can receive and respond to the communicated commands and render the responses via the user interface as visual or audio output.

Continuing with the example of FIG. 1, the base station 114 is configured to interoperate with the other location-based devices to provide local command and control and store-and-forward functionality via execution of the surveillance client 136. In some examples, to implement store-and-forward functionality, the base station 114, through execution of the surveillance client 136, receives sensor data, packages the data for transport, and stores the packaged sensor data in local memory for subsequent communication. This communication of the packaged sensor data can include, for instance, transmission of the packaged sensor data as a payload of a message to one or more of the transport services 126 when a communication link to the transport services 126 via the network 118 is operational. In some examples, packaging the sensor data can include filtering the sensor data and/or generating one or more summaries (maximum values, minimum values, average values, changes in values since the previous communication of the same, etc.) of multiple sensor readings. To implement local command and control functionality, the base station 114 executes, under control of the surveillance client 136, a variety of programmatic operations in response to various events. Examples of these events can include reception of commands from the keypad 108 or the customer interface application 132, reception of commands from one of the monitor interfaces 130 or the customer interface application 132 via the network 118, or detection of the occurrence of a scheduled event. The programmatic operations executed by the base station 114 under control of the surveillance client 136 can include activation or deactivation of one or more of the devices 104, 106, 108, 110, and 112; sounding of an alarm; reporting an event to the surveillance service 128; and communicating location data to one or more of the transport services 126 to name a few operations. The location data can include data specifying sensor readings (sensor data), configuration data of any of the location-based devices, commands input and received from a user (e.g., via the keypad 108 or a customer interface 132), or data derived from one or more of these data types (e.g., filtered sensor data, summarizations of sensor data, event data specifying an event detected at the location via the sensor data, etc.).

Continuing with the example of FIG. 1, the transport services 126 are configured to securely, reliably, and efficiently exchange messages between processes implemented by the location-based devices and processes implemented by other devices in the system 100. These other devices can include the customer devices 122, devices disposed in the data center environment 124, and/or devices disposed in the monitoring center environment 120. In some examples, the transport services 126 are also configured to parse messages from the location-based devices to extract payloads included therein and store the payloads and/or data derived from the payloads within one or more data stores hosted in the data center environment 124. The data housed in these data stores may be subsequently accessed by, for example, the surveillance service 128, the monitor interfaces 130, and the customer interfaces 132.

In certain examples, the transport services 126 expose and implement one or more application programming interfaces (APIs) that are configured to receive, process, and respond to calls from processes (e.g., the surveillance client 136) implemented by base stations (e.g., the base station 114) and/or processes (e.g., the camera agent 138) implemented by other devices (e.g., the image capture device 110). Individual instances of a transport service within the transport services 126 can be associated with and specific to certain manufactures and models of location-based monitoring equipment (e.g., SIMPLISAFE equipment, RING equipment, etc.). The APIs can be implemented using a variety of architectural styles and interoperability standards. For instance, in one example, the API is a web services interface implemented using a representational state transfer (REST) architectural style. In this example, API calls are encoded in Hypertext Transfer Protocol (HTTP) along with JavaScript Object Notation (JSON) and/or extensible markup language (XML). These API calls are addressed to one or more uniform resource locators (URLs) that are API endpoints monitored by the transport services 126. In some examples, portions of the HTTP communications are encrypted to increase security. Alternatively or additionally, in some examples, the API is implemented as an MQTT broker that receives messages and transmits responsive messages to MQTT clients hosted by the base stations and/or the other devices. Alternatively or additionally, in some examples, the API is implemented using simple file transfer protocol commands. Thus, the transport services 126 are not limited to a particular protocol or architectural style. It should be noted that, in at least some examples, the transport services 126 can transmit one or more API calls to location-based devices to request data from, or an interactive communication session with, the location-based devices.

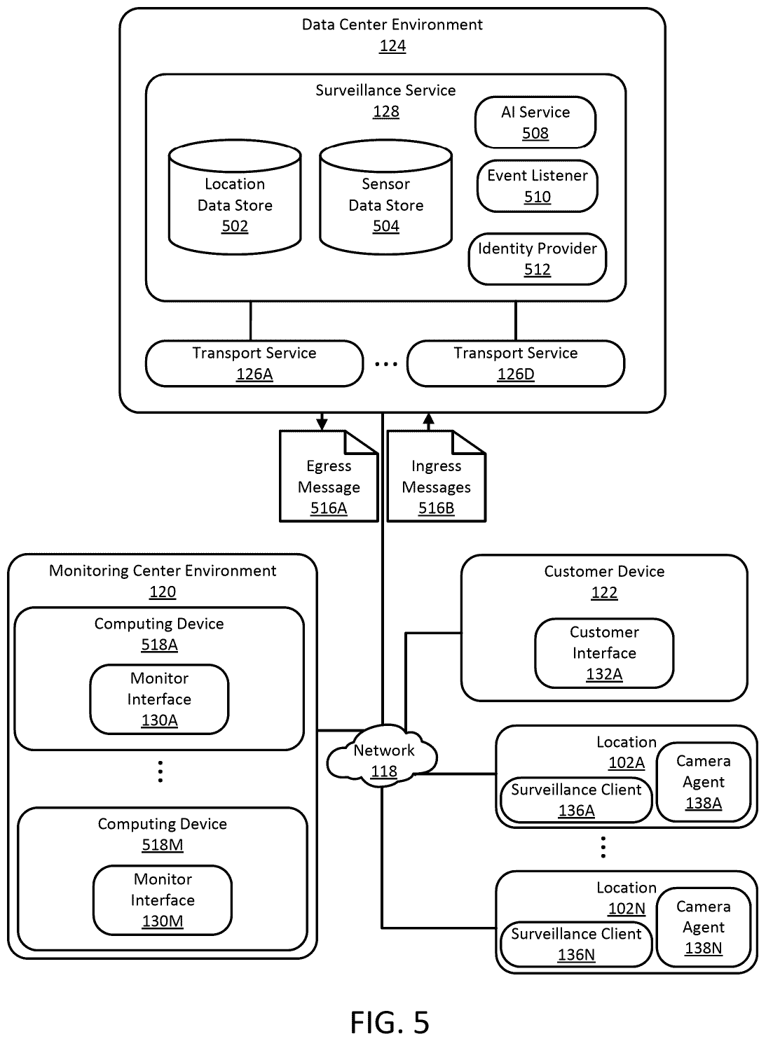

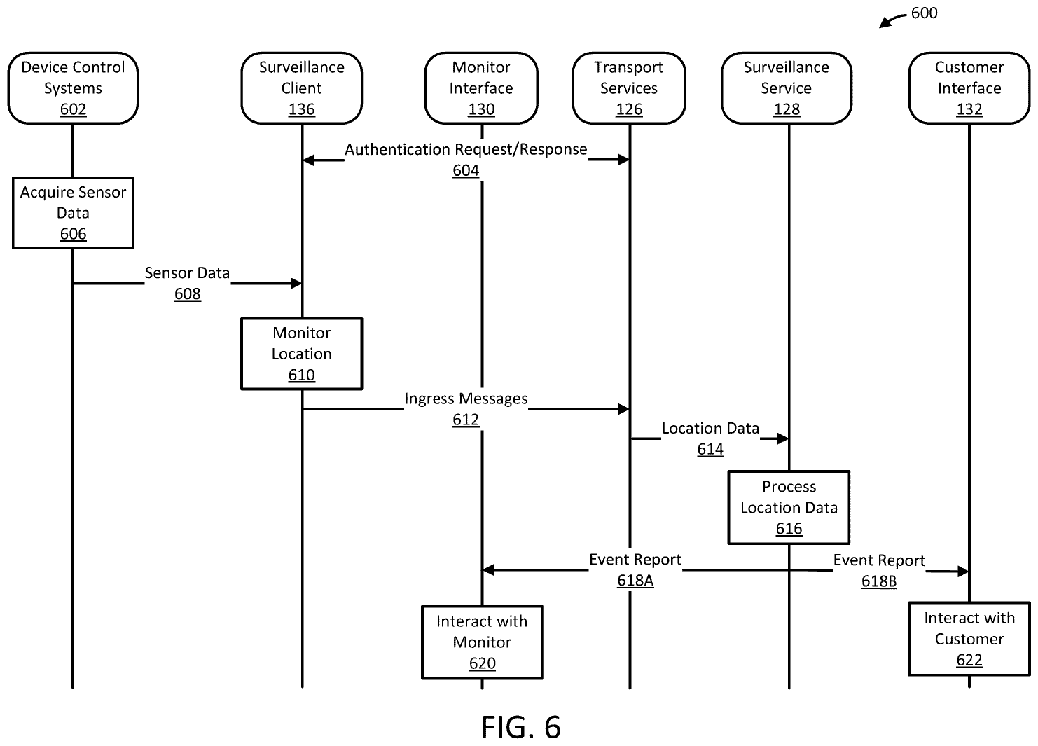

Continuing with the example of FIG. 1, the surveillance service 128 is configured to control overall logical setup and operation of the system 100. As such, the surveillance service 128 can interoperate with the transport services 126, the monitor interfaces 130, the customer interfaces 132, and any of the location-based devices. In some examples, the surveillance service 128 is configured to monitor data from a variety of sources for reportable events (e.g., a break-in event) and, when a reportable event is detected, notify one or more of the monitor interfaces 130 and/or the customer interfaces 132 of the reportable event. In some examples, the surveillance service 128 is also configured to maintain state information regarding the location 102A. This state information can indicate, for instance, whether the location 102A is safe or under threat. In certain examples, the surveillance service 128 is configured to change the state information to indicate that the location 102A is safe only upon receipt of a communication indicating a clear event (e.g., rather than making such a change in response to discontinuation of reception of break-in events). This feature can prevent a “crash and smash” robbery from being successfully executed. Further example processes that the surveillance service 128 is configured to execute are described below with reference to FIGS. 5 and 6.

Continuing with the example of FIG. 1, individual monitor interfaces 130 are configured to control computing device interaction with monitoring personnel and to execute a variety of programmatic operations in response to the interactions. For instance, in some examples, the monitor interface 130 controls its host device to provide information regarding reportable events detected at monitored locations, such as the location 102A, to monitoring personnel. Such events can include, for example, movement or an alarm condition generated by one or more of the location-based devices. Alternatively or additionally, in some examples, the monitor interface 130 controls its host device to interact with a user to configure features of the system 100. Further example processes that the monitor interface 130 is configured to execute are described below with reference to FIG. 6. It should be noted that, in at least some examples, the monitor interfaces 130 are browser-based applications served to the monitoring center environment 120 by webservers included within the data center environment 124. These webservers may be part of the surveillance service 128, in certain examples.

Continuing with the example of FIG. 1, individual customer interfaces 132 are configured to control computing device interaction with a customer and to execute a variety of programmatic operations in response to the interactions. For instance, in some examples, the customer interface 132 controls its host device to provide information regarding reportable events detected at monitored locations, such as the location 102A, to the customer. Such events can include, for example, an alarm condition generated by one or more of the location-based devices. Alternatively or additionally, in some examples, the customer interface 132 is configured to process input received from the customer to activate or deactivate one or more of the location-based devices. Further still, in some examples, the customer interface 132 configures features of the system 100 in response to input from a user. Further example processes that the customer interface 132 is configured to execute are described below with reference to FIG. 6.

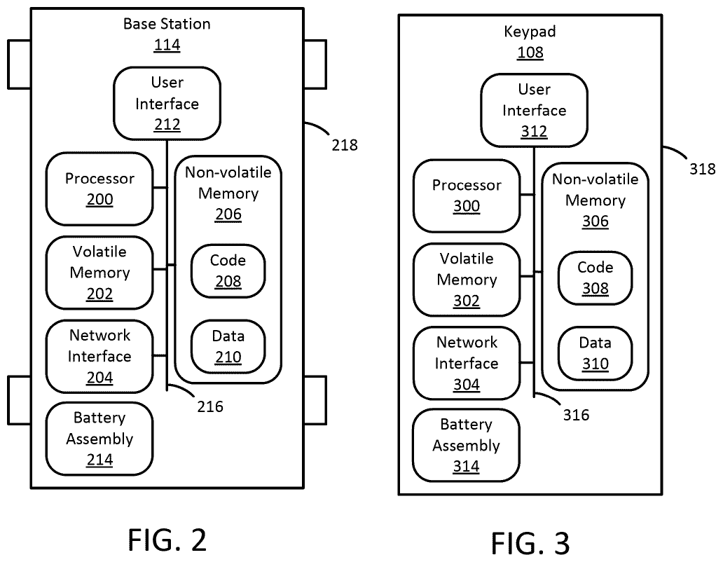

Turning now to FIG. 2, an example base station 114 is schematically illustrated. As shown in FIG. 2, the base station 114 includes at least one processor 200, volatile memory 202, non-volatile memory 206, at least one network interface 204, a user interface 212, a battery assembly 214, and an interconnection mechanism 216. The non-volatile memory 206 stores executable code 208 and includes a data store 210. In some examples illustrated by FIG. 2, the features of the base station 114 enumerated above are incorporated within, or are a part of, a housing 218.

In some examples, the non-volatile (non-transitory) memory 206 includes one or more read-only memory (ROM) chips; one or more hard disk drives or other magnetic or optical storage media; one or more solid state drives (SSDs), such as a flash drive or other solid-state storage media; and/or one or more hybrid magnetic and SSDs. In certain examples, the code 208 stored in the non-volatile memory can include an operating system and one or more applications or programs that are configured to execute under the operating system. Alternatively or additionally, the code 208 can include specialized firmware and embedded software that is executable without dependence upon a commercially available operating system. Regardless, execution of the code 208 can implement the surveillance client 136 of FIG. 1 and can result in manipulated data that is a part of the data store 210.

Continuing the example of FIG. 2, the processor 200 can include one or more programmable processors to execute one or more executable instructions, such as a computer program specified by the code 208, to control the operations of the base station 114. As used herein, the term “processor” describes circuitry that executes a function, an operation, or a sequence of operations. The function, operation, or sequence of operations can be hard coded into the circuitry or soft coded by way of instructions held in a memory device (e.g., the volatile memory 202) and executed by the circuitry. In some examples, the processor 200 is a digital processor, but the processor 200 can be analog, digital, or mixed. As such, the processor 200 can execute the function, operation, or sequence of operations using digital values and/or using analog signals. In some examples, the processor 200 can be embodied in one or more application specific integrated circuits (ASICs), microprocessors, digital signal processors (DSPs), graphics processing units (GPUs), neural processing units (NPUs), microcontrollers, field programmable gate arrays (FPGAs), programmable logic arrays (PLAs), or multicore processors. Examples of the processor 200 that are multicore can provide functionality for parallel, simultaneous execution of instructions or for parallel, simultaneous execution of one instruction on more than one piece of data.

Continuing with the example of FIG. 2, prior to execution of the code 208 the processor 200 can copy the code 208 from the non-volatile memory 206 to the volatile memory 202. In some examples, the volatile memory 202 includes one or more static or dynamic random access memory (RAM) chips and/or cache memory (e.g. memory disposed on a silicon die of the processor 200). Volatile memory 202 can offer a faster response time than a main memory, such as the non-volatile memory 206.

Through execution of the code 208, the processor 200 can control operation of the network interface 204. For instance, in some examples, the network interface 204 includes one or more physical interfaces (e.g., a radio, an ethernet port, a universal serial bus (USB) port, etc.) and a software stack including drivers and/or other code 208 that is configured to communicate with the one or more physical interfaces to support one or more LAN, PAN, and/or WAN standard communication protocols. The communication protocols can include, for example, transmission control protocol (TCP), user datagram protocol (UDP), HTTP, and MQTT among others. As such, the network interface 204 enables the base station 114 to access and communicate with other computing devices (e.g., the location-based devices) via a computer network (e.g., the LAN established by the router 116 of FIG. 1, the network 118 of FIG. 1, and/or a point-to-point connection). For instance, in at least one example, the network interface 204 utilizes sub-GHz wireless networking to transmit messages to other location-based devices. These messages can include wake messages to request streams of sensor data, alarm messages to trigger alarm responses, or other messages to initiate other operations. Bands that the network interface 204 may utilize for sub-GHz wireless networking include, for example, a 868 MHz band and/or a 915 MHz band. Use of sub-GHz wireless networking can improve operable communication distances and/or reduce power consumed to communicate.

Through execution of the code 208, the processor 200 can control operation of the user interface 212. For instance, in some examples, the user interface 212 includes user input and/or output devices (e.g., a keyboard, a mouse, a touchscreen, a display, a speaker, a camera, an accelerometer, a biometric scanner, an environmental sensor, etc.) and a software stack including drivers and/or other code 208 that is configured to communicate with the user input and/or output devices. For instance, the user interface 212 can be implemented by a customer device 122 hosting a mobile application (e.g., a customer interface 132). The user interface 212 enables the base station 114 to interact with users to receive input and/or render output. This rendered output can include, for instance, one or more graphical user interfaces (GUIs) including one or more controls configured to display output and/or receive input. The input can specify values to be stored in the data store 210. The output can indicate values stored in the data store 210. It should be noted that, in some examples, parts of the user interface 212 are accessible and/or visible as part of, or through, the housing 218. These parts of the user interface 212 can include, for example, one or more light-emitting diodes (LEDs). Alternatively or additionally, in some examples, the user interface 212 includes a 95 dB siren that the processor 200 sounds to indicate that a break-in event has been detected.

Continuing with the example of FIG. 2, the various features of the base station 114 described above can communicate with one another via the interconnection mechanism 216. In some examples, the interconnection mechanism 216 includes a communications bus. In addition, in some examples, the battery assembly 214 is configured to supply operational power to the various features of the base station 114 described above. In some examples, the battery assembly 214 includes at least one rechargeable battery (e.g., one or more NiMH or lithium batteries). In some examples, the rechargeable battery has a runtime capacity sufficient to operate the base station 114 for 24 hours or longer while the base station 114 is disconnected from or otherwise not receiving line power. Alternatively or additionally, in some examples, the battery assembly 214 includes power supply circuitry to receive, condition, and distribute line power to both operate the base station 114 and recharge the rechargeable battery. The power supply circuitry can include, for example, a transformer and a rectifier, among other circuitry, to convert AC line power to DC device and recharging power.

Turning now to FIG. 3, an example keypad 108 is schematically illustrated. As shown in FIG. 3, the keypad 108 includes at least one processor 300, volatile memory 302, non-volatile memory 306, at least one network interface 304, a user interface 312, a battery assembly 314, and an interconnection mechanism 316. The non-volatile memory 306 stores executable code 308 and a data store 310. In some examples illustrated by FIG. 3, the features of the keypad 108 enumerated above are incorporated within, or are a part of, a housing 318.

In some examples, the respective descriptions of the processor 200, the volatile memory 202, the non-volatile memory 206, the interconnection mechanism 216, and the battery assembly 214 with reference to the base station 114 are applicable to the processor 300, the volatile memory 302, the non-volatile memory 306, the interconnection mechanism 316, and the battery assembly 314 with reference to the keypad 108. As such, those descriptions will not be repeated.

Continuing with the example of FIG. 3, through execution of the code 308, the processor 300 can control operation of the network interface 304. In some examples, the network interface 304 includes one or more physical interfaces (e.g., a radio, an ethernet port, a USB port, etc.) and a software stack including drivers and/or other code 308 that is configured to communicate with the one or more physical interfaces to support one or more LAN, PAN, and/or WAN standard communication protocols. These communication protocols can include, for example, TCP, UDP, HTTP, and MQTT among others. As such, the network interface 304 enables the keypad 108 to access and communicate with other computing devices (e.g., the other location-based devices) via a computer network (e.g., the LAN established by the router 116 and/or a point-to-point connection).

Continuing with the example of FIG. 3, through execution of the code 308, the processor 300 can control operation of the user interface 312. In some examples, the user interface 312 includes user input and/or output devices (e.g., physical keys arranged as a keypad, a touchscreen, a display, a speaker, a camera, a biometric scanner, an environmental sensor, etc.) and a software stack including drivers and/or other code 308 that is configured to communicate with the user input and/or output devices. As such, the user interface 312 enables the keypad 108 to interact with users to receive input and/or render output. This rendered output can include, for instance, one or more GUIs including one or more controls configured to display output and/or receive input. The input can specify values to be stored in the data store 310. The output can indicate values stored in the data store 310. It should be noted that, in some examples, parts of the user interface 312 (e.g., one or more LEDs) are accessible and/or visible as part of, or through, the housing 318.

In some examples, devices like the keypad 108, which rely on user input to trigger an alarm condition, may be included within a security system, such as the security system 100 of FIG. 1. Examples of such devices include dedicated key fobs and panic buttons. These dedicated security devices provide a user with a simple, direct way to trigger an alarm condition, which can be particularly helpful in times of duress.

Turning now to FIG. 4A, an example security sensor 422 is schematically illustrated. Particular configurations of the security sensor 422 (e.g., the image capture devices 104 and 110, the motion sensor assembly 112, and the contact sensor assemblies 106) are illustrated in FIG. 1 and described above. Other examples of security sensors 422 include glass break sensors, carbon monoxide sensors, smoke detectors, water sensors, temperature sensors, and door lock sensors, to name a few. As shown in FIG. 4A, the security sensor 422 includes at least one processor 400, volatile memory 402, non-volatile memory 406, at least one network interface 404, a battery assembly 414, an interconnection mechanism 416, and at least one sensor assembly 420. The non-volatile memory 406 stores executable code 408 and a data store 410. Some examples include a user interface 412. As indicated by its rendering in dashed lines, not all examples of the security sensor 422 include the user interface 412. In certain examples illustrated by FIG. 4A, the features of the security sensor 422 enumerated above are incorporated within, or are a part of, a housing 418.

In some examples, the respective descriptions of the processor 200, the volatile memory 202, the non-volatile memory 206, the interconnection mechanism 216, and the battery assembly 214 with reference to the base station 114 are applicable to the processor 400, the volatile memory 402, the non-volatile memory 406, the interconnection mechanism 416, and the battery assembly 414 with reference to the security sensor 422. As such, those descriptions will not be repeated.

Continuing with the example of FIG. 4A, through execution of the code 408, the processor 400 can control operation of the network interface 404. In some examples, the network interface 404 includes one or more physical interfaces (e.g., a radio (including an antenna), an ethernet port, a USB port, etc.) and a software stack including drivers and/or other code 408 that is configured to communicate with the one or more physical interfaces to support one or more LAN, PAN, and/or WAN standard communication protocols. The communication protocols can include, for example, TCP, UDP, HTTP, and MQTT among others. As such, the network interface 404 enables the security sensor 422 to access and communicate with other computing devices (e.g., the other location-based devices) via a computer network (e.g., the LAN established by the router 116 and/or a point-to-point connection). For instance, in at least one example, when executing the code 408, the processor 400 controls the network interface to stream (e.g., via UDP) sensor data acquired from the sensor assembly 420 to the base station 114. Alternatively or additionally, in at least one example, through execution of the code 408, the processor 400 can control the network interface 404 to enter a power conservation mode by powering down a 2.4 GHz radio and powering up a sub-GHz radio that are both included in the network interface 404. In this example, through execution of the code 408, the processor 400 can control the network interface 404 to enter a streaming or interactive mode by powering up a 2.4 GHz radio and powering down a sub-GHz radio, for example, in response to receiving a wake signal from the base station via the sub-GHz radio.

Continuing with the example of FIG. 4A, through execution of the code 408, the processor 400 can control operation of the user interface 412. In some examples, the user interface 412 includes user input and/or output devices (e.g., physical buttons, a touchscreen, a display, a speaker, a camera, an accelerometer, a biometric scanner, an environmental sensor, one or more LEDs, etc.) and a software stack including drivers and/or other code 408 that is configured to communicate with the user input and/or output devices. As such, the user interface 412 enables the security sensor 422 to interact with users to receive input and/or render output. This rendered output can include, for instance, one or more GUIs including one or more controls configured to display output and/or receive input. The input can specify values to be stored in the data store 410. The output can indicate values stored in the data store 410. It should be noted that, in some examples, parts of the user interface 412 are accessible and/or visible as part of, or through, the housing 418.

Continuing with the example of FIG. 4A, the sensor assembly 420 can include one or more types of sensors, such as the sensors described above with reference to the image capture devices 104 and 110, the motion sensor assembly 112, and the contact sensor assembly 106 of FIG. 1, or other types of sensors. For instance, in at least one example, the sensor assembly 420 includes an image sensor (e.g., a charge-coupled device or an active-pixel sensor) and/or a temperature or thermographic sensor (e.g., an active and/or passive infrared (PIR) sensor). Regardless of the type of sensor or sensors housed, the processor 400 can (e.g., via execution of the code 408) acquire sensor data from the housed sensor and stream the acquired sensor data to the processor 400 for communication to the base station.

It should be noted that, in some examples of the devices 108 and 422, the operations executed by the processors 300 and 400 while under control of respective control of the code 308 and 408 may be hardcoded and/or implemented in hardware, rather than as a combination of hardware and software. Moreover, execution of the code 408 can implement the camera agent 138 of FIG. 1 and can result in manipulated data that is a part of the data store 410.

Turning now to FIG. 4B, an example image capture device 500 is schematically illustrated. Particular configurations of the image capture device 500 (e.g., the image capture devices 104 and 110) are illustrated in FIG. 1 and described above. As shown in FIG. 4B, the image capture device 500 includes at least one processor 400, volatile memory 402, non-volatile memory 406, at least one network interface 404, a battery assembly 414, and an interconnection mechanism 416. These features of the image capture device 500 are illustrated in dashed lines to indicate that they reside within a housing 418. The non-volatile memory 406 stores executable code 408 and a data store 410.

Some examples further include an image sensor assembly 450, a light 452, a speaker 454, a microphone 456, a wall mount 458, and a magnet 460. The image sensor assembly 450 may include a lens and an image sensor (e.g., a charge-coupled device or an active-pixel sensor) and/or a temperature or thermographic sensor (e.g., an active and/or passive infrared (PIR) sensor). The light 452 may include a light emitting diode (LED), such as a red-green-blue emitting LED. The light 452 may also include an infrared emitting diode in some examples. The speaker 454 may include a transducer configured to emit sound in the range of 60 dB to 80 dB or louder. Further, in some examples, the speaker 454 can include a siren configured to emit sound in the range of 70 dB to 90 dB or louder. The microphone 456 may include a micro electro-mechanical system (MEMS) microphone. The wall mount 458 may include a mounting bracket, configured to accept screws or other fasteners that adhere the bracket to a wall, and a cover configured to mechanically couple to the mounting bracket. In some examples, the cover is composed of a magnetic material, such as aluminum or stainless steel, to enable the magnet 460 to magnetically couple to the wall mount 458, thereby holding the image capture device 500 in place.

In some examples, the respective descriptions of the processor 400, the volatile memory 402, the network interface 404, the non-volatile memory 406, the code 408 with respect to the network interface 404, the interconnection mechanism 416, and the battery assembly 414 with reference to the security sensor 422 are applicable to these same features with reference to the image capture device 500. As such, those descriptions will not be repeated here.

Continuing with the example of FIG. 4B, through execution of the code 408, the processor 400 can control operation of the image sensor assembly 450, the light 452, the speaker 454, and the microphone 456. For instance, in at least one example, when executing the code 408, the processor 400 controls the image sensor assembly 450 to acquire sensor data, in the form of image data, to be stream to the base station 114 (or one of the processes 130, 128, or 132 of FIG. 1) via the network interface 404. Alternatively or additionally, in at least one example, through execution of the code 408, the processor 400 controls the light 452 to emit light so that the image sensor assembly 450 collects sufficient reflected light to compose the image data. Further, in some examples, through execution of the code 408, the processor 400 controls the speaker 454 to emit sound. This sound may be locally generated (e.g., a sonic alarm via the siren) or streamed from the base station 114 (or one of the processes 130, 128, or 132 of FIG. 1) via the network interface 404 (e.g., utterances from the user or monitoring personnel). Further still, in some examples, through execution of the code 408, the processor 400 controls the microphone 456 to acquire sensor data in the form of sound for streaming to the base station 114 (or one of the processes 130, 128, or 132 of FIG. 1) via the network interface 404.

It should be appreciated that in the example of FIG. 4B, the light 452, the speaker 454, and the microphone 456 implement an instance of the user interface 412 of FIG. 4A. It should also be appreciated that the image sensor assembly 450 and the light 452 implement an instance of the sensor assembly 420 of FIG. 4A. As such, the image capture device 500 illustrated in FIG. 4B is at least one example of the security sensor 422 illustrated in FIG. 4A. The image capture device 500 may be a battery-powered outdoor sensor configured to be installed and operated in an outdoor environment, such as outside a home, office, store, or other commercial or residential building, for example.

Turning now to FIG. 4C, another example image capture device 520 is schematically illustrated. Particular configurations of the image capture device 520 (e.g., the image capture devices 104 and 110) are illustrated in FIG. 1 and described above. As shown in FIG. 4C, the image capture device 520 includes at least one processor 400, volatile memory 402, non-volatile memory 406, at least one network interface 404, a battery assembly 414, and an interconnection mechanism 416. These features of the image capture device 520 are illustrated in dashed lines to indicate that they reside within a housing 418. The non-volatile memory 406 stores executable code 408 and a data store 410. The image capture device 520 further includes an image sensor assembly 450, a speaker 454, and a microphone 456 as described above with reference to the image capture device 500 of FIG. 4B.

In some examples, the image capture device 520 further includes lights 452A and 452B. The light 452A may include a light emitting diode (LED), such as a red-green-blue emitting LED. The light 452B may also include an infrared emitting diode to enable night vision in some examples.

It should be appreciated that in the example of FIG. 4C, the lights 452A and 452B, the speaker 454, and the microphone 456 implement an instance of the user interface 412 of FIG. 4A. It should also be appreciated that the image sensor assembly 450 and the light 452 implement an instance of the sensor assembly 420 of FIG. 4A. As such, the image capture device 520 illustrated in FIG. 4C is at least one example of the security sensor 422 illustrated in FIG. 4A. The image capture device 520 may be a battery-powered indoor sensor configured to be installed and operated in an indoor environment, such as within a home, office, store, or other commercial or residential building, for example.

Turning now to FIG. 5, aspects of the data center environment 124 of FIG. 1, the monitoring center environment 120 of FIG. 1, one of the customer devices 122 of FIG. 1, the network 118 of FIG. 1, and a plurality of monitored locations 102A through 102N of FIG. 1 (collectively referred to as the locations 102) are schematically illustrated. As shown in FIG. 5, the data center environment 124 hosts the surveillance service 128 and the transport services 126 (individually referred to as the transport services 126A through 126D). The surveillance service 128 includes a location data store 502, a sensor data store 504, an artificial intelligence (AI) service 508, an event listening service 510, and an identity provider 512. The monitoring center environment 120 includes computing devices 518A through 518M (collectively referred to as the computing devices 518) that host monitor interfaces 130A through 130M. Individual locations 102A through 102N include base stations (e.g., the base station 114 of FIG. 1, not shown) that host the surveillance clients 136A through 136N (collectively referred to as the surveillance clients 136) and image capture devices (e.g., the image capture device 110 of FIG. 1, not shown) that host the software camera agents 138A through 138N (collectively referred to as the camera agents 138).

As shown in FIG. 5, the transport services 126 are configured to process ingress messages 516B from the customer interface 132A, the surveillance clients 136, the camera agents 138, and/or the monitor interfaces 130. The transport services 126 are also configured to process egress messages 516A addressed to the customer interface 132A, the surveillance clients 136, the camera agents 138, and the monitor interfaces 130. The location data store 502 is configured to store, within a plurality of records, location data in association with identifiers of customers for whom the location is monitored. For example, the location data may be stored in a record with an identifier of a customer and/or an identifier of the location to associate the location data with the customer and the location. The sensor data store 504 is configured to store, within a plurality of records, sensor data (e.g., one or more frames of image data) separately from other location data but in association with identifiers of locations and timestamps at which the sensor data was acquired. In some examples, the sensor data store 504 is optional and may be used, for example, where the sensor data house therein has specialized storage or processing requirements.

Continuing with the example of FIG. 5, the AI service 508 is configured to process sensor data (e.g., images and/or sequences of images) to identify movement, human faces, and other features within the sensor data. The event listening service 510 is configured to scan location data transported via the ingress messages 516B for event data and, where event data is identified, execute one or more event handlers to process the event data. In some examples, the event handlers can include an event reporter that is configured to identify reportable events and to communicate messages specifying the reportable events to one or more recipient processes (e.g., a customer interface 132 and/or a monitor interface 130). In some examples, the event listening service 510 can interoperate with the AI service 508 to identify events from sensor data. The identity provider 512 is configured to receive, via the transport services 126, authentication requests from the surveillance clients 136 or the camera agents 138 that include security credentials. When the identity provider 512 can authenticate the security credentials in a request (e.g., via a validation function, cross-reference look-up, or some other authentication process), the identity provider 512 can communicate a security token in response to the request. A surveillance client 136 or a camera agent 138 can receive, store, and include the security token in subsequent ingress messages 516B, so that the transport service 126A is able to securely process (e.g., unpack/parse) the packages included in the ingress messages 516B to extract the location data prior to passing the location data to the surveillance service 128.

Continuing with the example of FIG. 5, the transport services 126 are configured to receive the ingress messages 516B, verify the authenticity of the messages 516B, parse the messages 516B, and extract the location data encoded therein prior to passing the location data to the surveillance service 128 for processing. This location data can include any of the location data described above with reference to FIG. 1. Individual transport services 126 may be configured to process ingress messages 516B generated by location-based monitoring equipment of a particular manufacturer and/or model. The surveillance clients 136 and the camera agents 138 are configured to generate and communicate, to the surveillance service 128 via the network 118, ingress messages 516B that include packages of location data based on sensor information received at the locations 102.

Continuing with the example of FIG. 5, the computing devices 518 are configured to host the monitor interfaces 130. In some examples, individual monitor interfaces 130A-130M are configured to render GUIs including one or more image frames and/or other sensor data. In certain examples, the customer device 122 is configured to host the customer interface 132. In some examples, customer interface 132 is configured to render GUIs including one or more image frames and/or other sensor data. Additional features of the monitor interfaces 130 and the customer interface 132 are described further below with reference to FIG. 6.

Turning now to FIG. 6, a monitoring process 600 is illustrated as a sequence diagram. The process 600 can be executed, in some examples, by a security system (e.g., the security system 100 of FIG. 1). More specifically, in some examples, at least a portion of the process 600 is executed by the location-based devices under the control of device control system (DCS) code (e.g., either the code 308 or 408) implemented by at least one processor (e.g., either of the processors 300 or 400 of FIGS. 3-4C). The DCS code can include, for example, a camera agent (e.g., the camera agent 138 of FIG. 1). At least a portion of the process 600 is executed by a base station (e.g., the base station 114 of FIG. 1) under control of a surveillance client (e.g., the surveillance client 136 of FIG. 1). At least a portion of the process 600 is executed by a monitoring center environment (e.g., the monitoring center environment 120 of FIG. 1) under control of a monitor interface (e.g., the monitor interface 130 of FIG. 1). At least a portion of the process 600 is executed by a data center environment (e.g., the data center environment 124 of FIG. 1) under control of a surveillance service (e.g., the surveillance service 128 of FIG. 1) or under control of transport services (e.g., the transport services 126 of FIG. 1). At least a portion of the process 600 is executed by a customer device (e.g., the customer device 122 of FIG. 1) under control of a customer interface (e.g., customer interface 132 of FIG. 1).

As shown in FIG. 6, the process 600 starts with the surveillance client 136 authenticating with an identity provider (e.g., the identity provider 512 of FIG. 5) by exchanging one or more authentication requests and responses 604 with the transport service 126. More specifically, in some examples, the surveillance client 136 communicates an authentication request to the transport service 126 via one or more API calls to the transport service 126. In these examples, the transport service 126 parses the authentication request to extract security credentials therefrom and passes the security credentials to the identity provider for authentication. In some examples, if the identity provider authenticates the security credentials, the identity provider generates a security token and transmits the security token to the transport service 126. The transport service 126, in turn, receives a security token and communicates the security token as a payload within an authentication response to the authentication request. In these examples, if the identity provider is unable to authenticate the security credentials, the transport service 126 generates an error code and communicates the error code as the payload within the authentication response to the authentication request. Upon receipt of the authentication response, the surveillance client 136 parses the authentication response to extract the payload. If the payload includes the error code, the surveillance client 136 can retry authentication and/or interoperate with a user interface of its host device (e.g., the user interface 212 of the base station 114 of FIG. 2) to render output indicating the authentication failure. If the payload includes the security token, the surveillance client 136 stores the security token for subsequent use in communication of location data via ingress messages. It should be noted that the security token can have a limited lifespan (e.g., 1 hour, 1 day, 1 week, 1 month, etc.) after which the surveillance client 136 may be required to reauthenticate with the transport services 126.

Continuing with the process 600, one or more DCSs 602 hosted by one or more location-based devices acquire 606 sensor data descriptive of a location (e.g., the location 102A of FIG. 1). The sensor data acquired can be any of a variety of types, as discussed above with reference to FIGS. 1-4. In some examples, one or more of the DCSs 602 acquire sensor data continuously. In some examples, one or more of the DCSs 602 acquire sensor data in response to an event, such as expiration of a local timer (a push event) or receipt of an acquisition polling signal communicated by the surveillance client 136 (a poll event). In certain examples, one or more of the DCSs 602 stream sensor data to the surveillance client 136 with minimal processing beyond acquisition and digitization. In these examples, the sensor data may constitute a sequence of vectors with individual vector members including a sensor reading and a timestamp. Alternatively or additionally, in some examples, one or more of the DCSs 602 execute additional processing of sensor data, such as generation of one or more summaries of multiple sensor readings. Further still, in some examples, one or more of the DCSs 602 execute sophisticated processing of sensor data. For instance, if the security sensor includes an image capture device, the security sensor may execute image processing routines such as edge detection, motion detection, facial recognition, threat assessment, and reportable event generation.

Continuing with the process 600, the DCSs 602 communicate the sensor data 608 to the surveillance client 136. As with sensor data acquisition, the DCSs 602 can communicate the sensor data 608 continuously or in response to an event, such as a push event (originating with the DCSs 602) or a poll event (originating with the surveillance client 136).

Continuing with the process 600, the surveillance client 136 monitors 610 the location by processing the received sensor data 608. For instance, in some examples, the surveillance client 136 executes one or more image processing routines. These image processing routines may include any of the image processing routines described above with reference to the operation 606. By distributing at least some of the image processing routines between the DCSs 602 and surveillance clients 136, some examples decrease power consumed by battery-powered devices by off-loading processing to line-powered devices. Moreover, in some examples, the surveillance client 136 may execute an ensemble threat detection process that utilizes sensor data 608 from multiple, distinct DCSs 602 as input. For instance, in at least one example, the surveillance client 136 will attempt to corroborate an open state received from a contact sensor with motion and facial recognition processing of an image of a scene including a window to which the contact sensor is affixed. If two or more of the three processes indicate the presence of an intruder, the threat score is increased and or a break-in event is declared, locally recorded, and communicated. Other processing that the surveillance client 136 may execute includes outputting local alarms (e.g., in response to detection of particular events and/or satisfaction of other criteria) and detection of maintenance conditions for location-based devices, such as a need to change or recharge low batteries and/or replace/maintain the devices that host the DCSs 602. Any of the processes described above within the operation 610 may result in the creation of location data that specifies the results of the processes.

Continuing with the process 600, the surveillance client 136 communicates the location data 614 to the surveillance service 128 via one or more ingress messages 612 to the transport services 126. As with sensor data 608 communication, the surveillance client 136 can communicate the location data 614 continuously or in response to an event, such as a push event (originating with the surveillance client 136) or a poll event (originating with the surveillance service 128).

Continuing with the process 600, the surveillance service 128 processes 616 received location data. For instance, in some examples, the surveillance service 128 executes one or more routines described above with reference to the operations 606 and/or 610. Additionally or alternatively, in some examples, the surveillance service 128 calculates a threat score or further refines an existing threat score using historical information associated with the location identified in the location data and/or other locations geographically proximal to the location (e.g., within the same zone improvement plan (ZIP) code). For instance, in some examples, if multiple break-ins have been recorded for the location and/or other locations within the same ZIP code within a configurable time span including the current time, the surveillance service 128 may increase a threat score calculated by a DCS 602 and/or the surveillance client 136. In some examples, the surveillance service 128 determines, by applying a set of rules and criteria to the location data 614, whether the location data 614 includes any reportable events and, if so, communicates an event report 618A and/or 618B to the monitor interface 130 and/or the customer interface 132. A reportable event may be an event of a certain type (e.g., break-in) or an event of a certain type that satisfies additional criteria. For example, movement within a particular zone combined with a threat score that exceeds a threshold value may be a reportable event, while movement within the particular zone combined with a threat score that does not exceed a threshold value may be a non-reportable event. The event reports 618A and/or 618B may have a priority based on the same criteria used to determine whether the event reported therein is reportable or may have a priority based on a different set of criteria or rules.

Continuing with the process 600, the monitor interface 130 interacts 620 with monitoring personnel through, for example, one or more GUIs. These GUIs may provide details and context regarding one or more reportable events.

Continuing with the process 600, the customer interface 132 interacts 622 with at least one customer through, for example, one or more GUIs. These GUIs may provide details and context regarding one or more reportable events.

It should be noted that the processing of sensor data and/or location data, as described above with reference to the operations 606, 610, and 616, may be executed by processors disposed within various parts of the system 100. For instance, in some examples, the DCSs 602 execute minimal processing of the sensor data (e.g., acquisition and streaming only) and the remainder of the processing described above is executed by the surveillance client 136 and/or the surveillance service 128. This approach may be helpful to prolong battery runtime of location-based devices. In other examples, the DCSs 602 execute as much of the sensor data processing as possible, leaving the surveillance client 136 and the surveillance service 128 to execute only processes that require sensor data that spans location-based devices and/or locations. This approach may be helpful to increase scalability of the system 100 with regard to adding new locations.

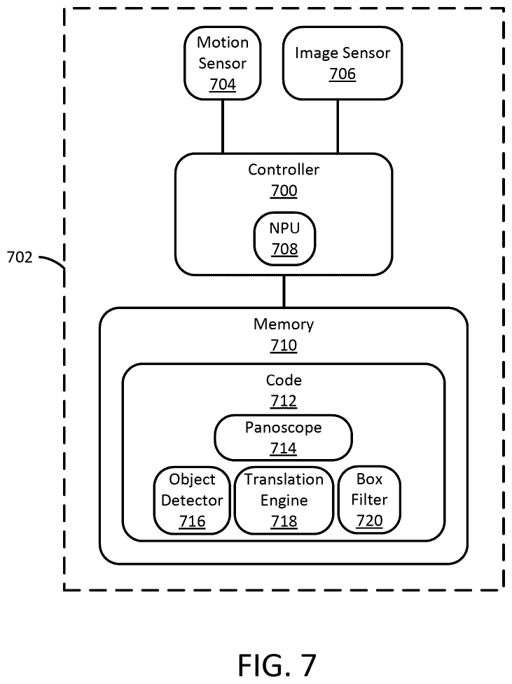

Turning now to FIG. 7, there is illustrated an example of a security device 702 configured to implement various techniques disclosed herein. The security device 702 can be associated with or otherwise a part of a security system at a monitored location, as discussed above. The security device 702 includes a motion sensor 704, an image sensor 706, and a memory 710 that are electrically coupled to a controller 700. The controller 700 may include or may be implemented by one or more processors, such as the processor 400 discussed above, for example. The security device 702 may further include any of the componentry and functionality of the security sensor 422 and/or image capture devices 500 and 520 discussed above with reference to FIGS. 4A-4C. Accordingly, it will be understood that the security device 702 may include components not shown in FIG. 7.

In one example, the motion sensor 704 is a PIR motion sensor. In one example, the image sensor 706 is a digital camera that collects still image frames and/or video image frames constituting a video feed/stream. The image sensor 706 may include the image sensor assembly 450 discussed above with reference to FIGS. 4B and 4C. In one example, the controller 700 includes an NPU 708 for efficiently applying artificial neural networks or other artificial intelligence models in execution of aspects of motion detection and object detection processes based on the image frames captured by the image sensor 706, as discussed in more detail below. In one example, the memory 710 includes non-volatile, flash memory and stores code 712 that is executable by the controller 700. The memory 710 may include the non-volatile memory 406 discussed above with reference to FIGS. 4A-4C. The code 712 includes a panoscope 714, an object detector 716, a translation engine 718, and a box filter 720. The processes that the code 712 is configured to execute via the security device 702 are described further below. The code 712 may include the code 408 discussed above with reference to FIGS. 4A-4C. The security device 702 may be a battery-powered indoor sensor configured to be installed and operated in an indoor environment, such as within a home, office, store, or other commercial or residential building, for example.

According to certain examples, the controller 700 and the motion sensor 704 operate in a low power state, or operating mode, in which the image sensor 706 (and optionally other components of the security device 702) are deactivated, until an occurrence triggers the motion sensor 704. In the low power operating mode, the motion sensor 704 remains active, but components that generally consume more power, such as the image sensor 706, for example, are powered off or otherwise inactive or dormant. In the low power operating mode, the controller 700 performs minimal processing, sufficient to monitor for events that trigger the motion sensor 704 to conserve battery life and thus extend the time between battery changeouts. When the motion sensor 704 indicates motion and issues a signal or notification (e.g., sends motion trigger data to the controller 700), the controller 700 is placed into a normal operating mode, in which the image sensor 706 (along with any other components of the security device 702 that are powered off in the low power state) is enabled or otherwise becomes active. Thus, the motion sensor 704 acts as a mode “switch” that configures the security device 702 into the “full power” or normal operating mode only when necessary. In this manner, power can be conserved by operating the security device 702 in the low power mode, with various components powered off, until a potential event of interest is detected and thereby extend the device's operation lifecycle when using battery power.

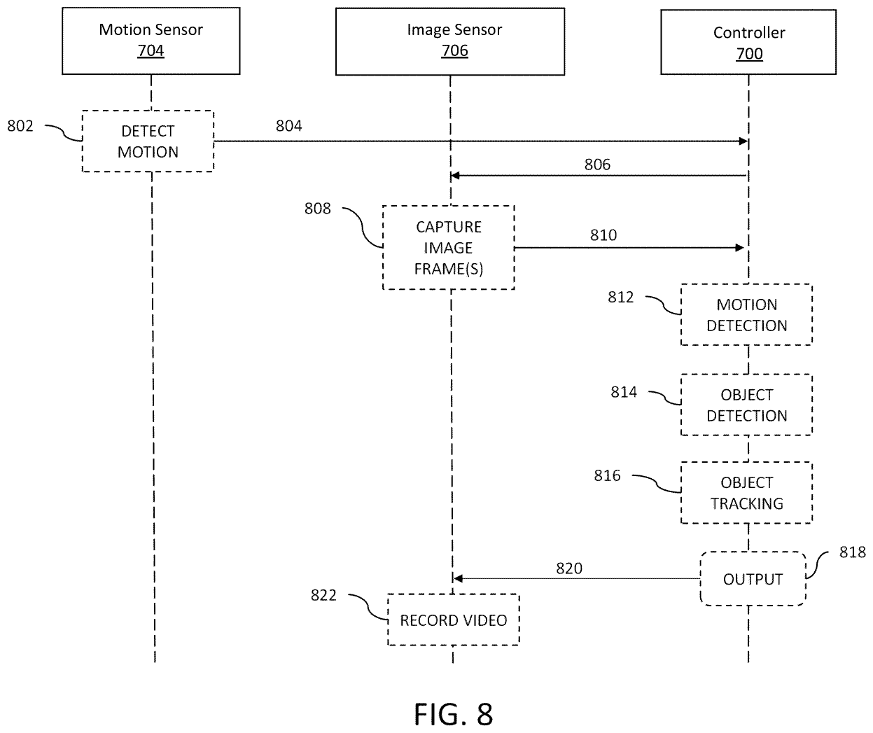

Referring to FIG. 8, there is illustrated a sequence diagram corresponding to an example of operation of the security device 702 of FIG. 7. With the security device 702 operating in the low power mode, the motion sensor 704 is active or otherwise powered on. At 802, the motion sensor 704 detects an occurrence (e.g., an object in motion) and sends a signal (e.g., motion trigger signal) to the controller 700, as indicated at 804. As discussed above, in certain examples the motion sensor 704 is a PIR sensor that detects motion based on detected changes in temperature over its field of view. Accordingly, in some examples, the motion sensor 704 can be tuned to detect people and/or animals based on a known temperature range associated with the body temperatures of people/animals. The signal from the motion sensor 704 causes the code 712, which is being executed by the controller 700, to configure the security device 702 into the normal operating mode, which includes activating or enabling the image sensor 706, as indicated at 806. Once active, at 808, the image sensor 706 captures one or more frames of image data. In some examples, the image sensor 706 passes the frame(s) of image data (“images” or “image frames”) to the controller 700 for processing, as indicated at 810. These frames of image data may be implemented as a two-dimensional array of pixel data (“pixels”). Other data structures and encoding standards for frames will be apparent in view of this disclosure.

According to certain examples, the controller 700 applies a motion detection process 812 that operates on captured frames of image data (e.g., from the image sensor 706) to detect instances of motion. In the example shown in FIG. 8, the process 812 is implemented by the controller 700. In examples, the controller 700 reads a single frame of image data at a time. In some examples, the controller 700 converts the frame to greyscale and resizes the frame for motion detection. In one example, the greyscale frame is resized (e.g., downsized) to 320×192 pixels for motion detection; however, in other examples, other frame sizes (e.g., 288×288 pixels) can be used. In some examples, downsizing the image frames may allow the images to be processed more quickly (e.g., using an artificial neural network (ANN)) and/or with less power consumption (which may be particularly beneficial for battery powered sensors) than if the process 812 was applied to full-size images captured by the image sensor 706.

It should be noted that, in some examples, the process 812 is implemented by a combination of the image sensor 706 and the controller 700. In these examples, the image sensor 706 obtains frames of image data and executes the preprocessing described above (e.g., converts to greyscale and/or resizes the frame). Further frames of image data can be acquired by the image sensor 706 as the process 812 continues and repeats various actions as discussed below.

Continuing with the process 812, the controller 700 operates on multiple frames (e.g., consecutive frames) of image data captured by the image sensor 706. In some examples of the process 812, the controller 700 locates where a moving object is in the field of view of the image sensor 706. The field of view of the image sensor 706 corresponds to the extent of the observable world that is “seen” (i.e., detected) at any given moment by the image sensor 706, which is generally the solid angle relative to the image sensor 706. In some examples, the solid angle defines an area through which a PIR sensor is sensitive to, and receives, electromagnetic radiation. Location of the object within the field of view can be determined using computer vision techniques. For example, there are existing foreground detection processes and/or background subtraction processes that can be used to locate moving objects in a frame of image data. These processes identify pixels that change between frames and produce bounding boxes where the pixels have changed. The motion detection processes can be tuned to reject noise (e.g., by using thresholding to reject small differences between consecutive image frames). Thus, the output of the motion detection process 812 includes bounding boxes describing the location of detected motion within the scene. Examples of programmatic libraries that implement and expose motion detection processes include OpenCV, which is available on the GitHub code repository.

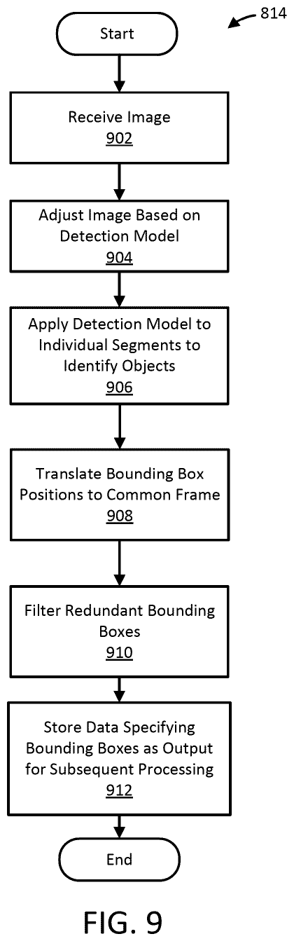

The controller 700 is further configured (optionally in combination with the image sensor 706) to implement an object detection process 814. In some examples, the motion detection process 812 and the object detection process 814 are executed concurrently via separate processing threads. In these examples, the motion detection process 812 may operate on image frames prior to the object detection process 814 and the object detection process 814 may skip some frames operated upon by the motion detection process, for example, to conserve computing resources. For instance, in some examples, the object detection process 814 is configured to operate on 1 to 10 frames per second, while the motion detection process 812 is configured to operate on 25 or more frames per second. In some examples, the object detection process 814 is configured to operate on 3 to 6 frames per second. In some examples, the object detection process 814 is configured to operate on 4 or 5 frames per second. A particular example of the object detection process 814 is illustrated in FIG. 9.

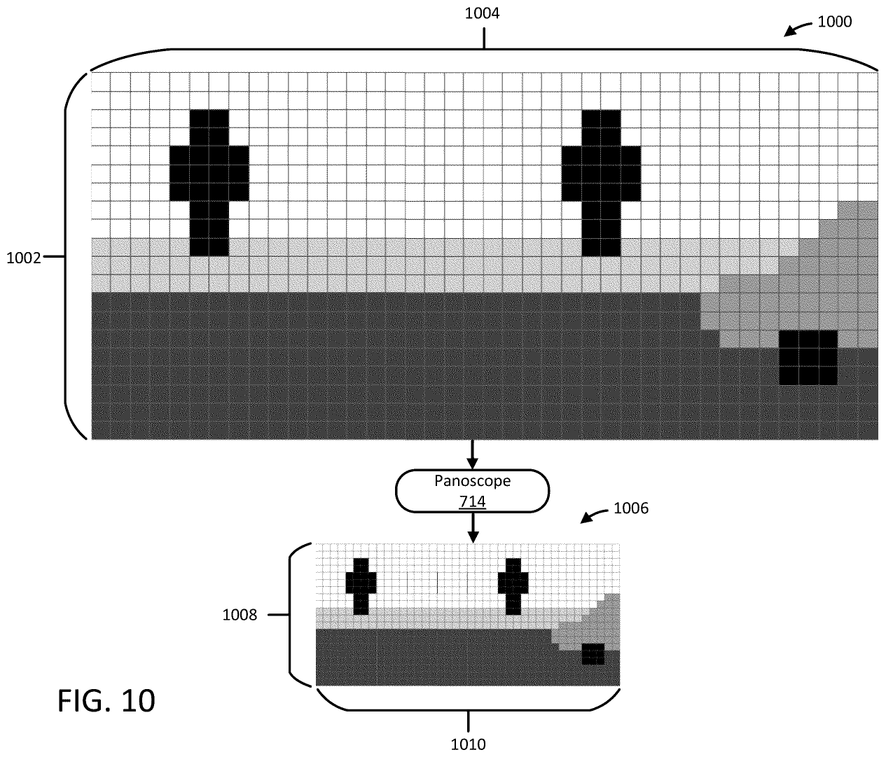

As shown in FIG. 9, the object detection process 814 starts with a controller (e.g., the controller 700 of FIG. 7) receiving 902 a frame of image data from an image capture device (e.g., the image sensor 706 of FIG. 7). For instance, in some examples, the image capture device acquires a frame of image data that captures its field of view via a lens and associated circuitry and stores the frame in a buffer accessible by the controller. FIG. 10 illustrates an example frame of image data 1000. As shown in FIG. 10, the frame 1000 has two dimensions-a height 1002 and a width 1004. The size, shape, and format of the frame can vary between examples. For instance, in some examples, the frame is a panoramic frame made up of 1920×1080 pixels encoded in a red-green-blue (RGB) color format. In other examples, the frame includes 1536×1536 pixels. Other potential sizes, shapes, and formats for the frame 1000 will be apparent in view of this disclosure.

Continuing with the process 814 as illustrated in FIG. 9, the controller adjusts 904 at least one characteristic of the frame. For instance, in some examples, the controller adjusts the frame based on one or more attributes of an object detection model to be applied to the frame or one or more portions thereof. The object detection model can be based on any of several available models, such as yolov4-slim, yolov3, yolov4, yolov5, etc. Some examples disclosed herein resize the frame to match at least one dimension of an operating resolution of an object detection model. As explained above, in certain devices (e.g., battery-powered devices, devices that are required to make inferences quickly, etc.) it may be advantageous to utilize object detection models with less computational complexity relative to other object detection models because such object detection models can be effectively executed with greater speed using processors that consume less power, among other benefits. As such, in some examples, within the operation 904 the controller adjusts (e.g., resizes, scales, pads, crops, etc.) frames of image data to create regions of interest sized and shaped to match that of image data used to train or otherwise configure the object detection model. Many different sizes (e.g., 0.3 megapixels, 0.48 megapixels, 0.78 megapixels, etc.) and shapes (square, rectangular, etc.) of frames of image data used to train object detection models will be apparent in view of this disclosure. As such, the operating resolution of object detection models can vary with some examples being 416×416 pixels, 512×512 pixels, and 640×360 pixels.

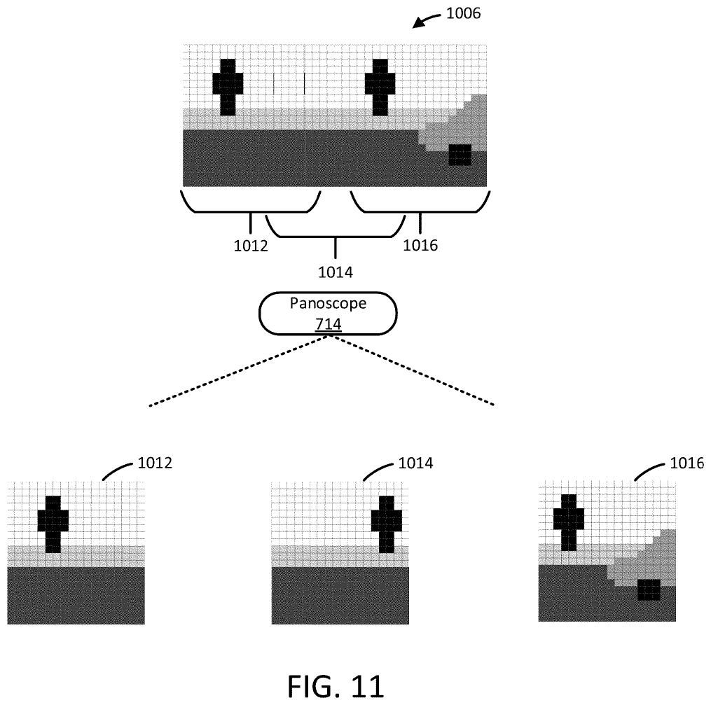

While adjustments made within the operation 904 can vary widely, in certain examples the adjustments are tailored for quick and efficient execution. For instance, continuing with the example involving the panoramic frame received within the operation 902, the controller may execute panoscope code (e.g., the panoscope 714 of FIG. 7) to both resize the frame 1000 and crop the resized frame into 3 regions of interest (e.g., a left region of interest, a center region of interest, and a right region of interest). These operations are illustrated in FIGS. 10 and 11. As shown in FIG. 10, the controller resizes the frame 1000 into a frame 1006 that has a height 1008 of 416 pixels and a width 1010 of 740 pixels. Next, as shown in FIG. 11, the controller crops the frame 1006 into 3 regions of interest 1012, 1014, and 1016. The individual regions of interest 1012, 1014, and 1016 have a height and a width of 416 pixels and, as such, adjacent regions of interest have overlapping pixels. In this example, the frame 1000 has been adjusted to the frame 1006 to fit an object detection model with a square processing resolution of 416 pixels. It should be noted that the operation 904 is not limited to the frame sizes, shapes, or pixel measurements described in this particular example and other frame sizes, shapes, and/or pixel measurements will be apparent in light of this disclosure. For instance, in some examples, the controller can divide a frame of image data into 2, 4, 5, or more regions of interest. The image data can be resized (e.g., downsized or upsized) to 512×288 pixels, 150×150 pixels, etc. in various examples. Moreover, the shape of the regions of interest may be square, rectangular, or another shape. In addition, the region of interest may or may not include overlapping pixels.

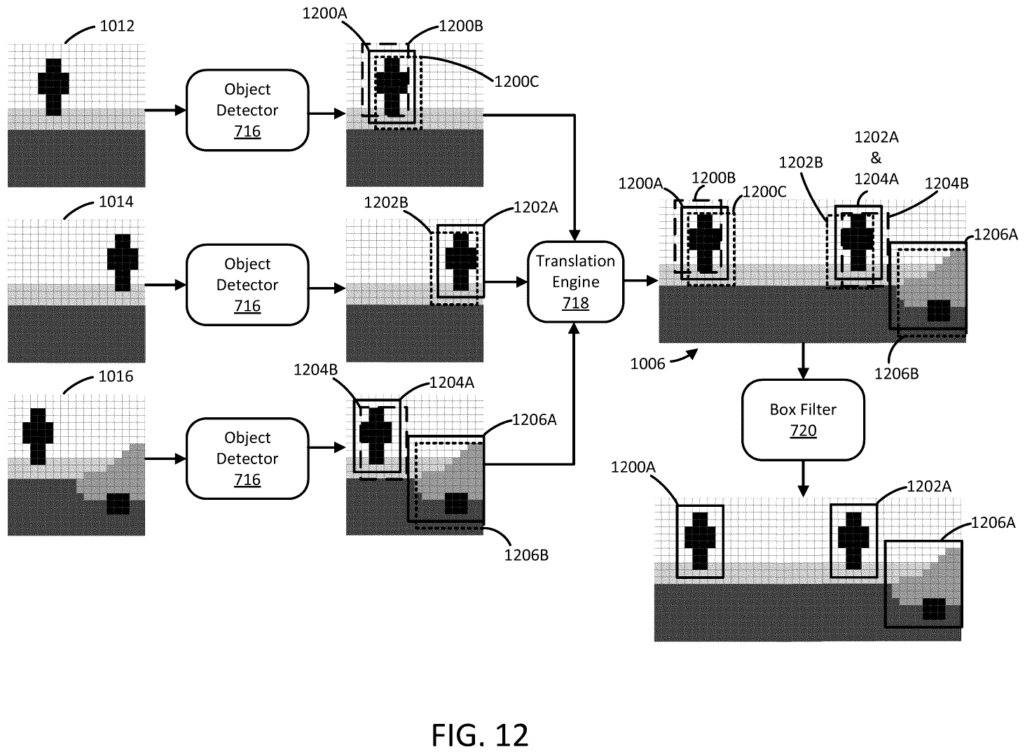

Continuing with the process 814 as illustrated in FIG. 9, the controller applies 906 the object detection model to the regions of interest to infer output from the regions of interest. For instance, in some examples, the controller executes object detection code (e.g., the object detector 716 of FIG. 7) to apply the object detection model to the regions of interest. Application of this model involves activation and execution of instructions by an NPU (e.g., the NPU 708 of FIG. 7) in some examples. Further, in some examples, the time consumed by the operation 906 falls within a range between 100 milliseconds and 350 milliseconds (e.g., 250 milliseconds). As one example, FIG. 12 illustrates the three regions of interest 1012, 1014, and 1016 to which the object detection model is applied by the controller. As can be seen, under control of the object detection model, the controller identifies three bounding boxes 1200A, 1200B, and 1200C within the region of interest 1012; two bounding boxes 1202A and 1202B in the region of interest 1014; and four bounding boxes 1204A, 1204B, 1206A, and 1206B in the region of interest 1016. In some examples, the object detection model tags individual bounding boxes with a confidence score that indicates a likelihood that the bounding box surrounds an object.

Continuing with the process 814 as illustrated in FIG. 9, the controller translates 908 the identified bounding boxes to a common frame of reference. For instance, in some examples, the controller executes translation engine code (e.g., the translation engine 718 of FIG. 7) to translate the identified bounding boxes to the frame of image data (e.g., the resized frame) from which the regions of interest were cropped in the operation 904. FIG. 12 illustrates the identified bounding boxes 1202A, 1202B, 1204A, 1204B, 1206A, and 1206B that are subject to translation by the controller. As can be seen, under control of the translation engine, the controller repositions the bounding boxes to a location within the frame 1006. In some examples, the controller performs this translation based on the locations of the bounding boxes within their corresponding regions of interest and the locations of the regions of interest within the frame of image data. For instance, the controller can translate all of the bounding boxes for a particular region of interest to their proper locations within the common frame by moving the region of interest to its original location within the common frame.

Continuing with the process 814 as illustrated in FIG. 9, the controller filters 910 the bounding boxes to remove redundant bounding boxes (e.g., bounding boxes corresponding to a same object). For instance, in some examples, the controller executes filter code (e.g., the box filter 720 of FIG. 7) to remove redundant bounding boxes. In certain examples, the controller filters the bounding boxes using a non-maximum suppression technique that identifies groups of overlapping bounding boxes (e.g., bounding boxes with an intersection-over-union of 0.5 or greater) and removes group members associated with lower confidence scores from individual groups. FIG. 12 illustrates the set of identified bounding boxes 1202A, 1202B, 1204A, 12048, 1206A, and 1206B that are subject to filtering by the controller. As can be seen, the bounding boxes 1200B, 1200C, 1202B, 1204A, 1204B, and 1206B are filtered from the set of identified bounding boxes-leaving 1200A, 1202A and 1206A to identify objects within the image data.

Continuing with the process 814 as illustrated in FIG. 9, the controller stores 912 data defining bounding boxes that surround objects within a data structure for subsequent processing. For instance, in some examples, the controller stores information specifying bounding boxes identified by the object detection model in a local data store (e.g., the data store 410 of FIGS. 4A-4C) within a data structure that associates or otherwise assigns bounding box information with or to frames of image data (e.g., the frame of image data 1006). As one example, FIG. 12 illustrates three bounding boxes 1200A, 1202A and 1206A that are associated with the frame 1006.

Returning to FIG. 8, the controller 700 is further configured to perform an object tracking process 816 on the outputs of the motion detection process 812 and the object detection process 814 to track and categorize detected objects, as discussed in more detail below. Based on applying the motion detection process 812, the object detection process 814, and the object tracking process 816 to the captured image frames 808, the controller 700 produces output 818 (e.g. different classes of output) These classes of output may include, for example, bounding boxes tagged with attributes of objects identified thereby, such as “moving person”, “stationary object”, “unknown object”, “moving vehicle”, “stationary vehicle”, or the like. Depending on the output 818, the security device 702 can take different actions. For example, as described further below, the controller 700 can be configured to generate (e.g., via the use of Kalman filters) a class of output 818 for recognized moving objects (recognized objects paired with motion) and stationary objects (detected objects that are not paired with motion). In examples, detection of stationary objects or of recognized moving objects that are not deemed to represent a threat will not cause the security device 702 to trigger an alarm. Instead, the controller 700 may deactivate the image sensor 706, and the security device 702 may return to the low power state until the motion sensor 704 detects a new occurrence of motion. On the other hand, detection of recognized moving objects that may represent a threat (such as people, for example) may cause the security device 702 to trigger an alarm. After triggering an alarm, the controller 700 may instruct the image sensor 706 (indicated at 820) to begin recording a video sequence at 822. The video sequence can be reviewed by a human operator (or a device hosting an artificial intelligence process) to determine whether or not to take further action.

Within the process 816, the controller 700 applies one or more AI models to the outputs from the motion detection process 812 and the object detection process 814 to track and categorize detected moving objects. For instance, in certain examples, the controller 700 controls the NPU 708 to apply one or more ANNs trained to produce the output(s) 818. In certain examples, the process 816 includes matching (or pairing) instances of detected motion with detected objects so as to identify and categorize moving objects. For example, if sufficient overlap exists between a first bounding box output from the motion detection process 812 and a second bounding box output from the object detection process 814, the controller 700 links the object associated with the first bounding box with the motion associated with the second bounding box to determine that the object is moving. In examples, the process 816 uses an implementation of the linear sum assignment algorithm to pair or match the first and second bounding boxes output from the motion detection process 812 and the object detection process 814, respectively. Thus, the pairing process can link detected motion (found during the motion detection process 812) with detected objects (identified during the object detection process 814) to produce the different classes of output 818, as discussed above.

In examples, a Kalman filter is used to track objects in the process 816. A Kalman filter is a control process that uses observations of measurements over time to predict future values of the measurements. The predictions of Kalman filters tend to be robust to noise and other inaccuracies present in the measurements. For individual frames (acquired at 808), the new object detection results (from 814) are compared to the set of currently tracked objects. If the first and second bounding boxes have any overlap, then the tracked objects are updated accordingly. If a detected object has no overlap with any currently tracked object, then a new tracked object is created. In examples, the process 816 includes a timeout feature such that tracked objects are deleted if they have not been updated within a period of time. In examples, detected motion (from the motion detection process 812) is also tracked from frame to frame using a Kalman filter, for example. As discussed above, the bounding boxes describing detected motion are compared with the bounding boxes describing tracked detected objects, and if there is overlap, the tracked object is tagged as a moving object. In contrast, a tracked object whose bounding box does not overlap with any bounding boxes output from the motion detection process 812 can be identified as a stationary object. Thus, the system can differentiate between moving objects and stationary objects.

In some examples, the output of the Kalman filter for a tracked object can be used to track detected motion. However, the shape of the bounding boxes may not be consistent frame-to-frame and therefore this could generate false motion. Accordingly, the above described examples use Kalman filters to independently track detected objects and detected motion, and pair the bounding boxes as discussed above to correlate objects with motion. Using the Kalman filters to track detected objects and detected motion over multiple image frames helps to reduce false positive alerts. In certain examples, the object detection process 814 can be tuned to detect one or more certain types of objects of interest with a relatively low threshold for certainty/confidence (e.g., with a low confidence indicator, as discussed above) that allows for false positives that are then filtered out during the object tracking process 816. In this manner, the system can be configured with an initial bias towards detection, so as to avoid missing an object of interest. However, the subsequent filtering can remove false positive detections before an alarm is triggered, thereby reducing the number of false alarms that a user of the security system receives. For example, using the Kalman filters to track objects and motion through multiple image frames allows the system to reject isolated instances of motion and/or object detection that are not repeated frame-to-frame and which therefore may represent noise or simply a detection error. Thus, the use of Kalman filters or other processes to track detections over multiple frames of image data can add robustness to false negatives and filter out false positives.

Turning now to FIG. 13, a computing device 1300 is illustrated schematically. As shown in FIG. 13, the computing device includes at least one processor 1302, volatile memory 1304, one or more interfaces 1306, non-volatile memory 1308, and an interconnection mechanism 1314. The non-volatile memory 1308 includes code 1310 and at least one data store 1312.

In some examples, the non-volatile (non-transitory) memory 1308 includes one or more read-only memory (ROM) chips; one or more hard disk drives or other magnetic or optical storage media; one or more solid state drives (SSDs), such as a flash drive or other solid-state storage media; and/or one or more hybrid magnetic and SSDs. In certain examples, the code 1310 stored in the non-volatile memory can include an operating system and one or more applications or programs that are configured to execute under the operating system. Alternatively or additionally, the code 1310 can include specialized firmware and embedded software that is executable without dependence upon a commercially available operating system. Regardless, execution of the code 1310 can result in manipulated data that may be stored in the data store 1312 as one or more data structures. The data structures may have fields that are associated through colocation in the data structure. Such associations may likewise be achieved by allocating storage for the fields in locations within memory that convey an association between the fields. However, other mechanisms may be used to establish associations between information in fields of a data structure, including through the use of pointers, tags, or other mechanisms.

Continuing the example of FIG. 13, the processor 1302 can be one or more programmable processors to execute one or more executable instructions, such as a computer program specified by the code 1310, to control the operations of the computing device 1300. As used herein, the term “processor” describes circuitry that executes a function, an operation, or a sequence of operations. The function, operation, or sequence of operations can be hard coded into the circuitry or soft coded by way of instructions held in a memory device (e.g., the volatile memory 1304) and executed by the circuitry. In some examples, the processor 1302 is a digital processor, but the processor 1302 can be analog, digital, or mixed. As such, the processor 1302 can execute the function, operation, or sequence of operations using digital values and/or using analog signals. In some examples, the processor 1302 can be embodied in one or more application specific integrated circuits (ASICs), microprocessors, digital signal processors (DSPs), graphics processing units (GPUs), neural processing units (NPUs), microcontrollers, field programmable gate arrays (FPGAs), programmable logic arrays (PLAs), or multicore processors. Examples of the processor 1302 that are multicore can provide functionality for parallel, simultaneous execution of instructions or for parallel, simultaneous execution of one instruction on more than one piece of data.

Continuing with the example of FIG. 13, prior to execution of the code 1310 the processor 1302 can copy the code 1310 from the non-volatile memory 1308 to the volatile memory 1304. In some examples, the volatile memory 1304 includes one or more static or dynamic random access memory (RAM) chips and/or cache memory (e.g. memory disposed on a silicon die of the processor 1302). Volatile memory 1304 can offer a faster response time than a main memory, such as the non-volatile memory 1308.

Through execution of the code 1310, the processor 1302 can control operation of the interfaces 1306. The interfaces 1306 can include network interfaces. These network interfaces can include one or more physical interfaces (e.g., a radio, an ethernet port, a USB port, etc.) and a software stack including drivers and/or other code 1310 that is configured to communicate with the one or more physical interfaces to support one or more LAN, PAN, and/or WAN standard communication protocols. The communication protocols can include, for example, TCP and UDP among others. As such, the network interfaces enable the computing device 1300 to access and communicate with other computing devices via a computer network.

The interfaces 1306 can include user interfaces. For instance, in some examples, the user interfaces include user input and/or output devices (e.g., a keyboard, a mouse, a touchscreen, a display, a speaker, a camera, an accelerometer, a biometric scanner, an environmental sensor, etc.) and a software stack including drivers and/or other code 1310 that is configured to communicate with the user input and/or output devices. As such, the user interfaces enable the computing device 1300 to interact with users to receive input and/or render output. This rendered output can include, for instance, one or more GUIs including one or more controls configured to display output and/or receive input. The input can specify values to be stored in the data store 1312. The output can indicate values stored in the data store 1312.

Continuing with the example of FIG. 13, the various features of the computing device 1300 described above can communicate with one another via the interconnection mechanism 1314. In some examples, the interconnection mechanism 1314 includes a communications bus.

Various innovative concepts may be embodied as one or more methods, of which examples have been provided. The acts performed as part of a method may be ordered in any suitable way. Accordingly, examples may be constructed in which acts are performed in an order different than illustrated, which may include performing some acts simultaneously, even though shown as sequential acts in illustrative examples.

Descriptions of additional examples follow. Other variations will be apparent in light of this disclosure.

Example 1 is a method including resizing a frame of pixels based on at least one dimension of an operating resolution; selecting a plurality of regions of interest within the frame; identifying an object based on pixels within at least one region of interest of the plurality of regions of interest; and issuing an alarm in response to the at least one region of interest including the object.

Example 2 includes the subject matter of Example 1, wherein resizing the frame of pixels comprises resizing a frame including 1920 pixels by 1080 pixels.

Example 3 includes the subject matter of Example 2, wherein resizing the frame of pixels comprises resizing the frame to a height of the operating resolution.

Example 4 includes the subject matter of Example 3, wherein resizing the frame to the height of the operating resolution comprises resizing a frame to a height of 416 pixels or a height of 512 pixels.

Example 5 includes the subject matter of Example 4, wherein selecting the plurality of regions of interest comprises selecting 3 regions of interest.

Example 6 includes the subject matter of Example 5, wherein selecting the 3 regions of interest comprises selecting 3 regions of interest to have individual widths of 416 pixels or individual widths of 512 pixels.

Example 7 includes the subject matter of Example 6, wherein identifying the object includes using a model.

Example 8 includes the subject matter of Example 7, wherein using the model comprises using a square model trained on input including 416 pixels by 416 pixels.

Example 9 includes the subject matter of any of Examples 1 through 8, wherein selecting the plurality of regions of interest comprises selecting a plurality of regions of interest in which adjacent regions of interest include overlapping pixels.

Example 10 includes the subject matter of Example 9, further including translating one or more bounding boxes to positions within a common frame.

Example 11 includes the subject matter of Example 10, further including filtering redundant bounding boxes from the common frame.

Example 12 includes the subject matter of any of Examples 1 through 11, wherein the operating resolution includes an operating resolution of a model.

Example 13 includes the subject matter of any of Examples 1 through 12, wherein identifying the object includes identifying the object subsequent to selection of the plurality of regions.

Example 14 is a device configured to communicate data generated by at least one sensor disposed in a location being monitored, the device comprising a memory; and at least one processor coupled with the memory and configured to resize a frame of pixels based on at least one dimension of an operating resolution; select a plurality of regions of interest within the frame; identify an object based on pixels within at least one region of interest of the plurality of regions of interest; and issue an alarm in response to the at least one region of interest including the object.

Example 15 includes the subject matter of Example 14, wherein the operating resolution includes an operating resolution of a model.

Example 16 includes the subject matter of Example 15, wherein to resize the frame of pixels comprises to resize the frame to a height of the operating resolution of the model.

Example 17 includes the subject matter of any of Examples 14 through 16, wherein to identify the object includes to identify the object subsequent to selection of the plurality of regions.

Example 18 includes one or more computer readable media storing sequences of instructions executable to identify objects depicted within images, the sequences of instructions comprising instructions to: resize a frame of pixels based on at least one dimension of an operating resolution; select a plurality of regions of interest within the frame; identify an object based on pixels within at least one region of interest of the plurality of regions of interest; and issue an alarm in response to the at least one region of interest including the object.

Example 19 includes the subject matter of Example 18, wherein to resize the frame of pixels comprises to resize the frame to a height of the operating resolution of a model.

Example 20 includes the subject matter of either Example 18 or Example 19, wherein to identify the object includes to identify the object subsequent to selection of the plurality of regions.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

Examples of the methods and systems discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

Having described several examples in detail, various modifications and improvements will readily occur to those skilled in the art. Such modifications and improvements are intended to be within the scope of this disclosure. Accordingly, the foregoing description is by way of example only, and is not intended as limiting.

1: A method comprising:
cropping a frame of pixels into an initial set of image data;
down-sampling or up-sampling at least some image data of the initial set based on a dimension of an operating resolution, thereby producing a secondary set of image data of different resolution than the initial set;
identifying an object based on pixels within the secondary set of image data;
identifying a bounding box surrounding the object in the secondary set of image data;
translating a location of the bounding box from the secondary set of image data to a location of the bounding box in the frame of pixels; and
issuing an alarm in response to the frame of pixels including the object.

2: The method of claim 1, wherein the frame of pixels has dimensions of 1920 pixels by 1080 pixels, and wherein the secondary set of image data includes a region of interest having dimensions of less than 1920 pixels by less than 1080 pixels.

3: The method of claim 2, wherein the region of interest has a height of the operating resolution.

4: The method of claim 3, wherein the region of interest has a height of 416 pixels or a height of 512 pixels.

5: The method of claim 4, wherein the initial set of image data includes 3 sets of image data.

6: The method of claim 5, wherein the secondary set of image data includes a region of interest having a width of 416 pixels or 512 pixels.

7: The method of claim 6, wherein identifying the object includes using a model.

8: The method of claim 7, wherein using the model comprises using a square model trained on input including 416 pixels by 416 pixels.

9: The method of claim 1, wherein the initial set of image data includes adjacent subframes having overlapping pixels.

10: The method of claim 9, wherein:
the secondary set of image data includes a first region of interest and a second region of interest;
identifying the object based on pixels within the secondary set of image data includes identifying the object in the first region of interest and in the second region of interest;
identifying the bounding box surrounding the object in the secondary set of image data includes identifying a first bounding box surrounding the object in the first region of interest and identifying a second bounding box surrounding the object in the second region of interest; and
translating the location of the bounding box includes (a) converting a location of the first bounding box in the first region of interest to a corresponding first location in the frame of pixels, and (b) translating a location of the second bonding box in the second region of interest to a corresponding second location in the frame of pixels.

11: The method of claim 10, further comprising selecting one of the first location in the frame of pixels or the second location in the frame of pixels.

12: The method of claim 1, wherein the operating resolution includes an operating resolution of a model.

13: (canceled)

14: A device configured to communicate data generated by at least one sensor disposed in a location being monitored, the device comprising:
a memory; and
at least one processor coupled with the memory and configured to
crop a frame of pixels into an initial set of image data,
down-sample or up-sample at least some image data of the initial set based on a dimension of an operating resolution to produce a secondary set of image data of different resolution than the initial set;
identify an object based on pixels within the secondary set of image data,
identify a bounding box surrounding the object in the secondary set of image data,
translate a location of the bounding box from the secondary set of image data to a location of the bounding box in the frame of pixels, and
issue an alarm in response to the frame of pixels including the object.

15: The device of claim 14, wherein the operating resolution includes an operating resolution of a model.

16: The device of claim 15, wherein the secondary set of image data include a region of interest having a height of the operating resolution of the model.

17: The device of claim 15, wherein identifying the object includes using the model.

18: One or more non-transitory computer readable media storing sequences of instructions executable to identify objects depicted within images, the sequences of instructions comprising instructions to:
crop a frame of pixels into an initial set of image data;
down-sample or up-sample at least some image data of the initial set based on a dimension of an operating resolution, thereby producing a secondary set of image data of different resolution than the initial set;
identify an object based on pixels within the secondary set of image data;
identify a bounding box surrounding the object in the secondary set of image data;
translate a location of the bounding box from the secondary set of image data to a location of the bounding box in the frame of pixels; and
issue an alarm in response to the frame of pixels including the object.

19: The one or more non-transitory computer readable media of claim 18, wherein the frame of pixels has a height of the operating resolution of a model.

20: The one or more non-transitory computer readable media of claim 19, wherein identifying the object includes using the model.

21: The one or more non-transitory computer readable media of claim 18, wherein the initial set of image data includes three adjacent subframes having overlapping pixels.
